(19) United States
(12) Patent Application Publication
(10) Pub. No.: US 2025/0321364 A1
(43) Pub. Date: Oct. 16, 2025

(54) SURFACE MODIFIED OPHTHALMIC DEVICES

(71) Applicant: Bausch + Lomb Ireland Limited, Dublin (IE)

(72) Inventors: Sankarsan Biswas, Webster, NY (US); Mohammad Vatankhah Varnosfaderani, Rochester, NY (US); Mark R. Mis, Rush, NY (US); Feng-Yang Shih, North Chili, NY (US); Alok Kumar Awasthi, Pittsford, NY (US)

(21) Appl. No.: 19/098,191

(22) Filed: Apr. 2, 2025

Related U.S. Application Data
(60) Provisional application No. 63/633,993, filed on Apr. 15, 2024.

(51) Int. Cl. G02B 1/18; A45C 11/00; C09D 133/24

(52) U.S. Cl. CPC G02B 1/18; A45C 11/005; C09D 133/24

(57) ABSTRACT

A surface modified ophthalmic device includes an ophthalmic device having one or more surface reactive functional groups and a surface coating, the surface coating including a coating composition including (a) a copolymer comprising (i) monomeric units derived from an ethylenically unsaturated containing monomer having ring-opening reactive functionalities, and (ii) monomeric units derived from a hydrophilic monomer having an ethylenically unsaturated reactive group, and (b) a hydrophilic polymer having reactive functional groups, wherein first ones of the ring-opening reactive functionalities of the ethylenically unsaturated containing monomer are complementary to the one or more surface reactive functional groups of the ophthalmic device and second ones of the ring-opening reactive functionalities of the ethylenically unsaturated containing monomer are complementary to the reactive functional groups of the hydrophilic polymer.

### PRIORITY CLAIM

The present application claims priority to U.S. Provisional Patent Application Ser. No. 63/633,993, entitled “Surface Modified Silicone Ophthalmic Devices,” filed Apr. 15, 2024, the content of which is incorporated by reference herein in its entirety.

### BACKGROUND

Ophthalmic devices such as contact lenses made from, for example, silicone-containing materials, have been investigated for a number of years. Such materials can generally be subdivided into two major classes, namely hydrogels and non-hydrogels. Hydrogels can absorb and retain water in an equilibrium state, whereas non-hydrogels do not absorb appreciable amounts of water. Regardless of their water content, both hydrogel and non-hydrogel silicone medical devices tend to have relatively hydrophobic, non-wettable surfaces that have a high affinity for lipids. This problem is of particular concern with contact lenses.

Those skilled in the art have long recognized the need for modifying the surface of the ophthalmic devices such as silicone contact lenses so that they are compatible with the eye. For example, by increasing the hydrophilicity of a contact lens surface, the wettability of the contact lens can be improved. This, in turn, is associated with improved wear comfort of the contact lenses. Additionally, the surface of the lens can affect the lens's susceptibility to deposition, particularly the deposition of proteins and lipids resulting from tear fluid during lens wear. Accumulated deposition can cause eye discomfort or even inflammation. In the case of extended wear lenses (i.e., lenses used without daily removal of the lens before sleep), the surface is especially important, since extended wear lenses must be designed for high standards of comfort and biocompatibility over an extended period of time.

### SUMMARY

In accordance with an illustrative embodiment, a surface modified ophthalmic device comprises an ophthalmic device having one or more surface reactive functional groups and a surface coating, the surface coating comprising a coating composition comprising (a) a copolymer comprising (i) monomeric units derived from an ethylenically unsaturated containing monomer having ring-opening reactive functionalities, and (ii) monomeric units derived from a hydrophilic monomer having an ethylenically unsaturated reactive group, and (b) a hydrophilic polymer having reactive functional groups, wherein first ones of the ring-opening reactive functionalities of the ethylenically unsaturated containing monomer are complementary to the one or more surface reactive functional groups of the ophthalmic device and second ones of the ring-opening reactive functionalities of the ethylenically unsaturated containing monomer are complementary to the reactive functional groups of the hydrophilic polymer.

In accordance with another illustrative embodiment, a method for making a surface modified ophthalmic device comprises exposing an ophthalmic device having one or more surface reactive functional groups to a coating composition comprising (a) a copolymer comprising (i) monomeric units derived from an ethylenically unsaturated containing monomer having ring-opening reactive functionalities, and (ii) monomeric units derived from a hydrophilic monomer having an ethylenically unsaturated reactive group, and (b) a hydrophilic polymer having reactive functional groups, wherein first ones of the ring-opening reactive functionalities of the ethylenically unsaturated containing monomer are complementary to the one or more surface reactive functional groups of the ophthalmic device and second ones of the ring-opening reactive functionalities of the ethylenically unsaturated containing monomer are complementary to the reactive functional groups of the hydrophilic polymer.

In accordance with yet another illustrative embodiment, a packaging system for the storage of a surface modified ophthalmic device comprises a sealed container containing an unused ophthalmic device immersed in an aqueous packaging solution comprising a coating composition comprising (a) a copolymer comprising (i) monomeric units derived from an ethylenically unsaturated containing monomer having ring-opening reactive functionalities, and (ii) monomeric units derived from a hydrophilic monomer having an ethylenically unsaturated reactive group, and (b) a hydrophilic polymer having reactive functional groups, wherein first ones of the ring-opening reactive functionalities of the ethylenically unsaturated containing monomer are complementary to the one or more surface reactive functional groups of the ophthalmic device and second ones of the ring-opening reactive functionalities of the ethylenically unsaturated containing monomer are complementary to the reactive functional groups of the hydrophilic polymer, wherein the aqueous packaging solution has an osmolality of at least about 150 mOsm/kg, a pH of about 6 to about 9 and is sterilized.

In accordance with still yet another illustrative embodiment, a method of preparing a packaging system comprises a storable, sterile surface modified ophthalmic device comprises:
(a) providing an unused ophthalmic device,
(b) immersing the unused ophthalmic device in an aqueous packaging solution comprising a coating composition comprising (i) a copolymer comprising (1) monomeric units derived from an ethylenically unsaturated containing monomer having ring-opening reactive functionalities, and (2) monomeric units derived from a hydrophilic monomer having an ethylenically unsaturated reactive group, and (ii) a hydrophilic polymer having reactive functional groups, wherein first ones of the ring-opening reactive functionalities of the ethylenically unsaturated containing monomer are complementary to the one or more surface reactive functional groups of the ophthalmic device and second ones of the ring-opening reactive functionalities of the ethylenically unsaturated containing monomer are complementary to the reactive functional groups of the hydrophilic polymer, wherein the aqueous packaging solution has an osmolality of at least about 150 mOsm/kg and a pH in the range of about 6 to about 9,
(c) packaging the aqueous packaging solution and the unused ophthalmic device in a manner preventing contamination of the unused ophthalmic device by microorganisms, and
(d) sterilizing the packaged solution and the unused ophthalmic device.

### DETAILED DESCRIPTION

Various illustrative embodiments described herein include surface modified ophthalmic devices. For example, by increasing the hydrophilicity on a surface of an ophthalmic device such as a contact lens surface, the wettability of the contact lens can be improved. This, in turn, is associated with improved wear comfort of the contact lenses. Additionally, the surface of the lens can affect the lens's susceptibility to deposition, particularly the deposition of proteins and lipids resulting from tear fluid during lens wear. Accumulated deposition can cause eye discomfort or even inflammation. In the case of extended wear lenses (i.e., lenses used without daily removal of the lens before sleep), the surface is especially important, since extended wear lenses must be designed for high standards of comfort and biocompatibility over an extended period of time.

Previous attempts at forming a surface modified ophthalmic device used a surface coating derived from a copolymer of glycidyl methacrylate and dimethylacrylamide. However, this surface coating failed to achieve the robustness necessary for use of the ophthalmic device in the human eye for an extended period of time. Accordingly, it would be desirable to provide improved ophthalmic devices having a highly wettable and/or lubricious surface coating that exhibits the robustness necessary for long term use of the ophthalmic device in the eye.

The non-limiting illustrative embodiments disclosed herein overcome the foregoing drawbacks by providing a surface modified ophthalmic device comprising an ophthalmic device having one or more surface reactive functional groups and a surface coating, the surface coating including a coating composition comprising (a) a copolymer comprising (i) monomeric units derived from an ethylenically unsaturated containing monomer having ring-opening reactive functionalities, and (ii) monomeric units derived from a hydrophilic monomer having an ethylenically unsaturated reactive group, and (b) a hydrophilic polymer having reactive functional groups, wherein first ones of the ring-opening reactive functionalities of the ethylenically unsaturated containing monomer are complementary to the one or more surface reactive functional groups of the ophthalmic device and second ones of the ring-opening reactive functionalities of the ethylenically unsaturated containing monomer are complementary to the reactive functional groups of the hydrophilic polymer.

The surface modified ophthalmic device according to the non-limiting illustrative embodiments described herein advantageously provides a robust interlocked surface coating on a surface of the ophthalmic device thereby allowing the use of the surface modified ophthalmic device in the human eye for an extended period of time. In addition, a surface modified ophthalmic device provides for uniformity of the surface coating along with an increase in lubricity on both anterior and posterior sides of the ophthalmic device. The robust interlocked surface coating is advantageously formed by utilizing a coating composition comprising a copolymer comprising (i) monomeric units derived from an ethylenically unsaturated containing monomer having ring-opening reactive functionalities, and (ii) monomeric units derived from a hydrophilic monomer having an ethylenically unsaturated reactive group, and (b) a hydrophilic polymer having reactive functional groups.

When contacting a surface of an ophthalmic device having one or more surface reactive functional groups, first ones of the ring-opening reactive functionalities of the ethylenically unsaturated containing monomer will attach to the one or more surface reactive functional groups to bond the copolymer to the surface of the ophthalmic device, and second ones of the ring-opening reactive functionalities of the ethylenically unsaturated containing monomer will react with the reactive functional groups of the hydrophilic polymer to interlock the copolymer and hydrophilic polymer to the surface of the ophthalmic device. In other words, a first set of ring-opening reactive functionalities from given ones of monomeric units derived from an ethylenically unsaturated containing monomer having ring-opening reactive functionalities will attach to the one or more surface reactive functional groups to bond the copolymer to the surface of the ophthalmic device, and a second set of ring-opening reactive functionalities from other given ones of the monomeric units derived from an ethylenically unsaturated containing monomer having ring-opening reactive functionalities will attach to the reactive functional groups of the hydrophilic polymer to interlock the copolymer and hydrophilic polymer to the surface of the ophthalmic device.

As one skilled in the art will readily appreciate, in some embodiments, there can be additional free ring-opening reactive functionalities from yet other given ones of the monomeric units derived from an ethylenically unsaturated containing monomer having ring-opening reactive functionalities that can attach to other free ring-opening reactive functionalities from still yet other given ones of the monomeric units derived from an ethylenically unsaturated containing monomer having ring-opening reactive functionalities in forming the surface modified ophthalmic device described herein.

As used herein, the term “ophthalmic device” refers to ophthalmic devices that reside in or on the eye. These devices can provide optical correction, wound care, drug delivery, diagnostic functionality or cosmetic enhancement or effect or a combination of these properties. Suitable ophthalmic devices include, for example, ophthalmic lenses such as soft contact lenses, e.g., a soft, hydrogel lens; soft, non-hydrogel lens and the like, hard contact lenses, e.g., a hard, gas permeable lens material and the like, intraocular lenses, overlay lenses, ocular inserts, optical inserts and the like. As is understood by one skilled in the art, a lens is considered to be “soft” if it can be folded back upon itself without breaking.

The type of ophthalmic device to be contacted with the coating composition disclosed herein is not critical and any ophthalmic device is contemplated. Representative examples of such ophthalmic device include, but are not limited to, soft contact lenses, e.g., a soft, hydrogel lens; soft, non-hydrogel lens and the like, hard contact lenses, e.g., a hard, gas permeable lens material and the like, rigid gas permeable (RGP) lenses, intraocular lenses, overlay lenses, and the like. Any material known to produce a contact lens can be used herein. For example, the contact lens treating solutions can be used with (1) hard lenses formed from materials prepared by polymerization of acrylic esters, such as poly(methyl methacrylate) (PMMA), (2) RGP lenses formed from silicone acrylates and fluorosilicone methacrylates, and (3) soft hydrogel contact lenses made of a hydrogel polymeric material, such as a silicone hydrogel, with a hydrogel being defined as a crosslinked polymeric system containing water in an equilibrium state.

The ophthalmic devices to be surface modified according to the non-limiting illustrative embodiments disclosed herein can be formed of any material known in the art capable of forming an ophthalmic device as described above. In one embodiment, ophthalmic devices include devices which are formed from materials not hydrophilic per se. Such devices are formed from materials known in the art and include, by way of example, polysiloxanes, perfluoropolyethers, fluorinated poly(meth)acrylates or equivalent fluorinated polymers derived, e.g., from other polymerizable carboxylic acids, polyalkyl (meth)acrylates or equivalent alkylester polymers derived from other polymerizable carboxylic acids, or fluorinated polyolefins, such as fluorinated ethylene propylene polymers, or tetrafluoroethylene, preferably in combination with a dioxol, e.g., perfluoro-2,2-dimethyl-1,3-dioxol. Representative examples of suitable bulk materials include, but are not limited to, Lotrafilcon A, Neofocon, Pasifocon, Telefocon, Silafocon, Fluorsilfocon, Paflufocon, Silafocon, Elastofilcon, Fluorofocon or Teflon AF materials, such as Teflon AF 1600 or Teflon AF 2400 which are copolymers of about 63 to about 73 mol % of perfluoro-2,2-dimethyl-1,3-dioxol and about 37 to about 27 mol % of tetrafluoroethylene, or of about 80 to about 90 mol % of perfluoro-2,2-dimethyl-1,3-dioxol and about 20 to about 10 mol % of tetrafluoroethylene.

In another embodiment, ophthalmic devices include devices which are formed from materials hydrophilic per se, since reactive groups, e.g., carboxy, carbamoyl, sulfate, sulfonate, phosphate, amine, ammonium or hydroxy groups, are inherently present in the material and therefore also at the surface of an ophthalmic device manufactured therefrom. Such devices are formed from materials known in the art and include, by way of example, one or more unsaturated carboxylic acids, vinyl lactams, amides, polymerizable amines, vinyl carbonates, vinyl carbamates, oxazolone monomers, copolymers thereof and the like and mixtures thereof. Useful amides include acrylamides such as N,N-dimethylacrylamide and N,N-dimethylmethacrylamide. Useful vinyl lactams include cyclic lactams such as N-vinyl-2-pyrrolidone. Examples of other hydrophilic monomers include hydrophilic prepolymers such as poly(alkene glycols) functionalized with polymerizable groups. Examples of useful functionalized poly(alkene glycols) include poly(diethylene glycols) of varying chain length containing monomethacrylate or dimethacrylate end caps. In some embodiments, the poly(alkene glycol) polymer contains at least two alkene glycol monomeric units. Still further examples are the hydrophilic vinyl carbonate or vinyl carbamate monomers disclosed in U.S. Pat. No. 5,070,215, and the hydrophilic oxazolone monomers disclosed in U.S. Pat. No. 4,910,277. Other suitable hydrophilic monomers will be apparent to one skilled in the art.

In another embodiment, a hydrogel material can contain a siloxane-containing monomer and at least one of the aforementioned hydrophilic monomers and/or prepolymers. In some embodiments, devices are formed from materials including, by way of example, polyhydroxyethyl acrylate, hydroxyethyl methacrylate (HEMA), polyvinyl pyrrolidone (PVP), polyacrylic acid, polymethacrylic acid, polyacrylamide, polydimethylacrylamide (DMA), polyvinyl alcohol and the like and copolymers thereof, e.g., from two or more monomers selected from hydroxyethyl acrylate, hydroxyethyl methacrylate, N-vinyl pyrrolidone, acrylic acid, methacrylic acid, acrylamide, dimethyl acrylamide, vinyl alcohol and the like. Representative examples of suitable bulk materials include, but are not limited to, Polymacon, Tefilcon, Methafilcon, Deltafilcon, Bufilcon, Phemfilcon, Ocufilcon, Focofilcon, Etafilcon, Hefilcon, Vifilcon, Tetrafilcon, Perfilcon, Droxifilcon, Dimefilcon, Isofilcon, Mafilcon, Nelfilcon, Atlafilcon and the like.

In another embodiment, ophthalmic devices include devices which are formed from materials which are amphiphilic segmented copolymers containing at least one hydrophobic segment and at least one hydrophilic segment which are linked through a bond or a bridge member.

It is particularly useful to employ biocompatible materials herein including both soft and rigid materials commonly used for ophthalmic lenses, including contact lenses. In general, non-hydrogel materials are hydrophobic polymeric materials that do not contain water in their equilibrium state. Typical non-hydrogel materials comprise silicone acrylics, such as those formed of a bulky silicone monomer (e.g., tris(trimethylsiloxy)silylpropyl methacrylate, commonly known as “TRIS” monomer), methacrylate end-capped poly(dimethylsiloxane) prepolymer, or silicones having fluoroalkyl side groups (polysiloxanes are also commonly known as silicone polymers).

On the other hand, hydrogel materials comprise hydrated, cross-linked polymeric systems containing water in an equilibrium state. Hydrogel materials contain about 5 wt. % water or more (up to, for example, about 80 wt. %). In one embodiment, hydrogel materials, include silicone hydrogel materials. In another embodiment, hydrogel materials include vinyl functionalized polydimethylsiloxanes copolymerized with hydrophilic monomers as well as fluorinated methacrylates and methacrylate functionalized fluorinated polyethylene oxides copolymerized with hydrophilic monomers. Representative examples of suitable hydrogel materials for use herein include those disclosed in U.S. Pat. Nos. 5,310,779; 5,387,662; 5,449,729; 5,512,205; 5,610,252; 5,616,757; 5,708,094; 5,710,302; 5,714,557 and 5,908,906, the contents of which are incorporated by reference herein.

In one embodiment, hydrogel materials for ophthalmic devices, such as contact lenses, can contain a hydrophilic monomer such as one or more unsaturated carboxylic acids, vinyl lactams, amides, polymerizable amines, vinyl carbonates, vinyl carbamates, oxazolone monomers, copolymers thereof and the like and mixtures thereof. Useful amides include acrylamides such as N,N-dimethylacrylamide and N,N-dimethylmethacrylamide. Useful vinyl lactams include cyclic lactams such as N-vinyl-2-pyrrolidone. Examples of other hydrophilic monomers include hydrophilic prepolymers such as poly(alkene glycols) functionalized with polymerizable groups. Examples of useful functionalized poly(alkene glycols) include poly(diethylene glycols) of varying chain length containing monomethacrylate or dimethacrylate end caps. In some embodiments, the poly(alkene glycol) polymer contains at least two alkene glycol monomeric units. Still further examples are the hydrophilic vinyl carbonate or vinyl carbamate monomers disclosed in U.S. Pat. No. 5,070,215, and the hydrophilic oxazolone monomers disclosed in U.S. Pat. No. 4,910,277. Other suitable hydrophilic monomers will be apparent to one skilled in the art. In another embodiment, a hydrogel material can contain a siloxane-containing monomer and at least one of the aforementioned hydrophilic monomers and/or prepolymers.

Representative examples of hydrophobic monomers include substitute or unsubstituted C₁ to C₂₀ alkyl and C₃ to C₂₀ cycloalkyl (meth)acrylates such as (2-amino)ethyl methacrylate and methacrylic acid, substituted and unsubstituted aryl (meth)acrylates (wherein the aryl group comprises 6 to 36 carbon atoms), (meth) acrylonitrile, styrene, lower alkyl styrene, lower alky vinyl ethers, and C₂ to C₁₀ perfluroalkyl (meth)acrylates and correspondingly partially fluorinate (meth)acrylates.

A wide variety of materials can be used herein, and silicone hydrogel contact lens materials are particularly preferred. Silicone hydrogels generally have a water content greater than about 5 wt. % and more commonly between about 10 wt. % to about 80 wt. %. Such materials are usually prepared by polymerizing a mixture containing at least one silicone-containing monomer and at least one hydrophilic monomer. Typically, either the silicone-containing monomer or the hydrophilic monomer functions as a crosslinking agent (a crosslinker being defined as a monomer having multiple polymerizable functionalities) or a separate crosslinker may be employed. Applicable silicone-containing monomers for use in the formation of silicone hydrogels are well known in the art and numerous examples are provided in U.S. Pat. Nos. 4,136,250; 4,153,641; 4,740,533; 5,034,461; 5,070,215; 5,260,000; 5,310,779; and 5,358,995.

Representative examples of applicable silicon-containing monomers include bulky silicone-containing monomers containing an ethylenically unsaturated reactive end group. The term “bulky” refers to groups on the silicone-containing monomers that are sterically and/or electronically encumbering, i.e., sterically hindering. In a non-limiting illustrative embodiment, suitable bulky silicone-containing monomers include, for example, a bulky polysiloxanylalkyl (meth)acrylic monomer, a bulky polysiloxanylalkyl carbamate monomer and mixtures thereof. A representative example of a bulky silicone-containing monomer includes a bulky polysiloxanylalkyl (meth)acrylic monomer represented by a structure of Formula Ia:

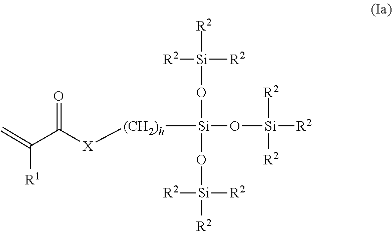

wherein X denotes —O— or —NR³—, where each R³ is hydrogen or a C₁-C₄ alkyl group; R¹ independently denotes hydrogen or methyl; each R² independently denotes a lower alkyl radical such as a C₁-C₆ group, a phenyl radical or a group represented by the following structure:

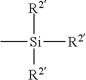

wherein each R^{2′} independently denotes a lower alkyl radical such as a C₁-C₆ group or a phenyl radical; and h is 1 to 10; or a bulky silicone-containing monomer represented by a structure of Formula Ib:

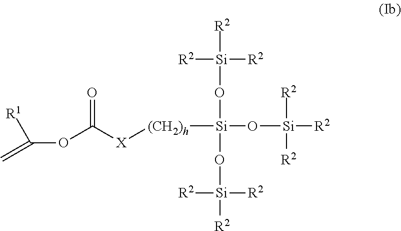

wherein X denotes —NR³— wherein R³ denotes hydrogen or a C₁-C₄ alkyl; R¹ denotes hydrogen or methyl; each R¹⁸ independently denotes a lower alkyl radical such as a C₁-C₆ group, a phenyl radical or a group represented by the following structure:

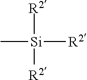

wherein each R^{2′} independently denotes a lower alkyl radical such as a C₁-C₆ group or a phenyl radical; and h is 1 to 10.

Representative examples of bulky silicone-containing monomers include 3-methacryloyloxypropyltris(trimethylsiloxy)silane or tris(trimethylsiloxy)silylpropyl methacrylate, sometimes referred to as TRIS, tris(trimethylsiloxy)silylpropyl vinyl carbamate, sometimes referred to as TRIS-VC, pentamethyldisiloxanyl methylmethacrylate, phenyltetramethyl-disiloxanylethyl acetate, and methyldi (trimethylsiloxy)methacryloxymethyl silane, (3-methacryloxy-2-hydroxy propoxy)propyl bis(trimethyl siloxy)methyl silane, sometimes referred to as Sigma and the like and mixtures thereof. In one embodiment, the bulky silicone-containing monomer is a tris(trialkylsiloxy)silylalkyl methacrylate-containing monomer such as a tris(trimethylsiloxy)silylpropyl methacrylate-containing monomer.

Such bulky monomers may be copolymerized with a silicone macromonomer, which is a poly(organosiloxane) capped with an unsaturated group at two or more ends of the molecule. U.S. Pat. No. 4,153,641 discloses, for example, various unsaturated groups such as acryloxy or methacryloxy groups.

Another class of representative silicone-containing monomers includes, but is not limited to, silicone-containing vinyl carbonate or vinyl carbamate monomers such as, for example, 1,3-bis [4-vinyloxycarbonyloxy) but-1-yl]tetramethyl-disiloxane; 3-(trimethylsilyl) propyl vinyl carbonate; 3-(vinyloxycarbonylthio) propyl-[tris(trimethylsiloxy) silane]; 3-[tris(trimethylsiloxy)silyl]propyl vinyl carbamate; 3-[tris(trimethylsiloxy)silyl]propyl allyl carbamate; 3-[tris(trimethylsiloxy)silyl]propyl vinyl carbonate; t-butyldimethylsiloxyethyl vinyl carbonate; trimethylsilylethyl vinyl carbonate; trimethylsilylmethyl vinyl carbonate and the like and mixtures thereof.

Another class of silicon-containing monomers includes polyurethane-polysiloxane macromonomers (also sometimes referred to as prepolymers), which may have hard-soft-hard blocks like traditional urethane elastomers. They may be end-capped with a hydrophilic monomer such as HEMA. Examples of such silicone urethanes are disclosed in a variety or publications, including Lai, Yu-Chin, “The Role of Bulky Polysiloxanylalkyl Methacryates in Polyurethane-Polysiloxane Hydrogels,” Journal of Applied Polymer Science, Vol. 60, 1193-1199 (1996). PCT Published Application No. WO 96/31792 discloses examples of such monomers, which disclosure is hereby incorporated by reference in its entirety. Further examples of silicone urethane monomers are represented by Formulae II and III:

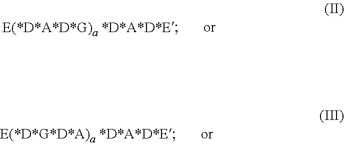

wherein:
   D independently denotes an alkyl diradical, an alkyl cycloalkyl diradical, a cycloalkyl diradical, an aryl diradical or an alkylaryl diradical having 6 to about 30 carbon atoms;
   G independently denotes an alkyl diradical, a cycloalkyl diradical, an alkyl cycloalkyl diradical, an aryl diradical or an alkylaryl diradical having 1 to about 40 carbon atoms and which may contain ether, thio or amine linkages in the main chain;
   * denotes a urethane or ureido linkage;
   a is at least 1;
   A independently denotes a divalent polymeric radical of Formula IV:

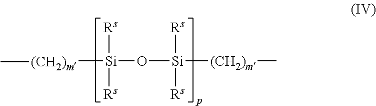

wherein each R^{s} independently denotes an alkyl or fluoro-substituted alkyl group having 1 to about 10 carbon atoms which may contain ether linkages between the carbon atoms; m′ is at least 1; and
p is a number that provides a moiety weight of about 400 to about 10,000;
   each of E and E′ independently denotes a polymerizable unsaturated organic radical represented by Formula V:

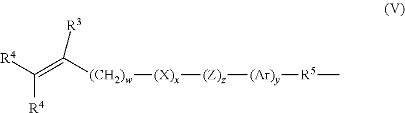

wherein: R³ is hydrogen or methyl;
R⁴ is hydrogen, an alkyl radical having 1 to 6 carbon atoms, or a —CO—Y—R⁶ radical wherein Y is —O—, —S— or —NH—;
R⁵ is a divalent alkylene radical having 1 to about 10 carbon atoms;
R⁶ is an alkyl radical having 1 to about 12 carbon atoms;
X denotes —CO— or —OCO—;
Z denotes —O— or —NH—;
Ar denotes an aromatic radical having about 6 to about 30 carbon atoms;
w is 0 to 6; x is 0 or 1; y is 0 or 1; and z is 0 or 1.

A preferred silicone-containing urethane monomer is represented by Formula VI:

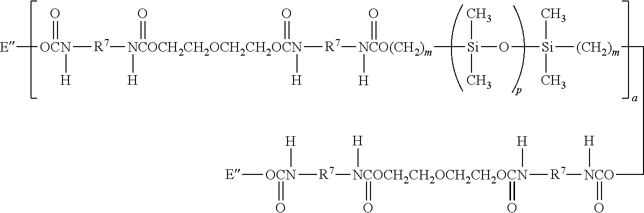

wherein m is at least 1 and is preferably 3 or 4, a is at least 1 and preferably is 1, p is a number which provides a moiety weight of about 400 to about 10,000 and is preferably at least about 30, R⁷ is a diradical of a diisocyanate after removal of the isocyanate group, such as the diradical of isophorone diisocyanate, and each E″ is a group represented by:

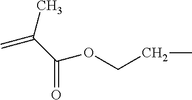

In another illustrative embodiment, a silicone hydrogel material comprises (in bulk, that is, in the monomer mixture that is copolymerized) about 5 to about 50 percent, and preferably about 10 to about 25, by weight of one or more silicone macromonomers, about 5 to about 75 percent, and preferably about 30 to about 60 percent, by weight of one or more polysiloxanylalkyl (meth)acrylic monomers, and about 10 to about 50 percent, and preferably about 20 to about 40 percent, by weight of a hydrophilic monomer. In general, the silicone macromonomer is a poly(organosiloxane) capped with an unsaturated group at two or more ends of the molecule. In addition to the end groups in the above structural formulas, U.S. Pat. No. 4,153,641 discloses additional unsaturated groups, including acryloxy or methacryloxy. Fumarate-containing materials such as those disclosed in U.S. Pat. Nos. 5,310,779; 5,449,729 and 5,512,205 are also useful substrates in accordance with the illustrative embodiments. The silane macromonomer may be a silicon-containing vinyl carbonate or vinyl carbamate or a polyurethane-polysiloxane having one or more hard-soft-hard blocks and end-capped with a hydrophilic monomer.

Another class of representative silicone-containing monomers includes fluorinated monomers. Such monomers have been used in the formation of fluorosilicone hydrogels to reduce the accumulation of deposits on contact lenses made therefrom, as disclosed in, for example, U.S. Pat. Nos. 4,954,587; 5,010,141 and 5,079,319. Also, the use of silicone-containing monomers having certain fluorinated side groups, i.e., —(CF₂)—H, have been found to improve compatibility between the hydrophilic and silicone-containing monomeric units. See, e.g., U.S. Pat. Nos. 5,321,108 and 5,387,662.

The above silicone materials are merely exemplary, and other materials for use as substrates that can benefit by being coated with the coating composition disclosed herein and have been disclosed in various publications and are being continuously developed for use in contact lenses and other medical devices can also be used. For example, an ophthalmic device can be formed from at least a cationic monomer such as cationic silicone-containing monomer or cationic fluorinated silicone-containing monomers.

As one skilled in the art will readily appreciate, the surface reactive functional groups of the ophthalmic device disclosed herein may be inherently present at the surface of the ophthalmic device. However, if the ophthalmic device contains too few or no functional groups, the surface of the ophthalmic device can be modified by known techniques, for example, plasma chemical methods or conventional functionalization with groups such as —OH, —NH₂ or —CO₂H. For example, the surface of the ophthalmic device can be treated with a plasma discharge or corona discharge to introduce or increase the population of ophthalmic device surface functional groups. The type of gas introduced into the treatment chamber will depend on the desired type of ophthalmic device surface functional group. For example, hydroxyl surface groups can be produced with a treatment chamber atmosphere containing water vapor or alcohols. Carboxyl surface groups can be produced with a treatment chamber atmosphere containing oxygen, air or another oxygen-containing gas. Amino surface groups can be produced with a treatment chamber atmosphere containing ammonia or an amine source. Mercaptan surface groups can be produced with a treatment chamber atmosphere containing sulfur-containing gases such as organic mercaptans or hydrogen sulfide. As one skilled in the art will readily appreciate, a combination of any of the foregoing gases can be used in the treatment chamber to produce a combination of ophthalmic device surface functional groups on the surface of the ophthalmic device. Methods and apparatus for surface treatment by plasma discharge are disclosed in, for example, U.S. Pat. Nos. 6,550,915 and 6,794,456, the contents of which are incorporated by reference herein.

Suitable ophthalmic device surface functional groups of the ophthalmic devices disclosed herein include a wide variety of groups well known to the skilled artisan. Representative examples of such functional groups include, but are not limited to, a hydroxy group, a tosylate group, a mesylate group, a triflate group, a nosyloxy group, an amino group, a carboxy group, a carbonyl group, an aldehyde group, a sulfonic acid group, a sulfonyl chloride group, an isocyanato group, a carboxy anhydride group, a lactone group, an azlactone group, an epoxy group, and mixtures thereof. In one embodiment, the ophthalmic device surface functional groups of the ophthalmic device are amino groups and/or hydroxy groups and/or carboxyl groups.

In non-limiting illustrative embodiments, as may be combined with one or more of the preceding paragraphs, the foregoing ophthalmic device having one or more surface reactive functional groups is then exposed to a coating composition comprising (a) a copolymer comprising (i) monomeric units derived from an ethylenically unsaturated containing monomer having ring-opening reactive functionalities, and (ii) monomeric units derived from a hydrophilic monomer having an ethylenically unsaturated reactive group, and (b) a hydrophilic polymer having reactive functional groups, wherein first ones of the ring-opening reactive functionalities of the ethylenically unsaturated containing monomer are complementary to the one or more surface reactive functional groups of the ophthalmic device and second ones of the ring-opening reactive functionalities of the ethylenically unsaturated containing monomer are complementary to the reactive functional groups of the hydrophilic polymer.

In some embodiments, the copolymer is a random copolymer. In an illustrative embodiment, the random copolymer is a brush copolymer. The term “polymer brushes,” as used herein is understood to mean a polymer brush that contains polymer chains, one end of which is directly or indirectly tethered to a surface and another end of which is free to extend from the surface, somewhat analogous to the bristles of a brush. In some embodiments, the random copolymer is a linear copolymer.

In some embodiments, the copolymer is a block copolymer. In an illustrative embodiment, the block copolymer is a brush copolymer. In an illustrative embodiment, the block copolymer is a linear copolymer.

Representative examples of the ethylenically unsaturated moiety of the ethylenically unsaturated containing monomer having ring-opening reactive functionalities include, by way of example, (meth)acrylate-containing radicals, (meth)acrylamido-containing radicals, vinylcarbonate-containing radicals, vinylcarbamate-containing radicals, styrene-containing radicals, itaconate-containing radicals, vinyl-containing radicals, vinyloxy-containing radicals, fumarate-containing radicals, maleimide-containing radicals, vinylsulfonyl radicals and the like. As used herein, the term “(meth)” denotes an optional methyl substituent. Thus, for example, terms such as “(meth)acrylate” denotes either methacrylate or acrylate, and “(meth)acrylamide” denotes either methacrylamide or acrylamide.

In an illustrative embodiment, ethylenically unsaturated containing monomers having ring-opening reactive functionalities that are complementary to the one or more surface reactive functional groups include ethylenically unsaturated epoxy-containing monomers. Suitable ethylenically unsaturated epoxy-containing monomers include, for example, glycidyl-containing ethylenically unsaturated monomers such as glycidyl methacrylate, glycidyl acrylate, glycidyl vinylcarbonate, glycidyl vinylcarbamate, vinylcyclohexyl-1,2-epoxide and the like. In some embodiments, an ethylenically unsaturated containing monomer having ring-opening reactive functionalities can contain from 2 to about 18 carbon atoms which is substituted by an epoxy group. In one embodiment, the ethylenically unsaturated containing monomer having ring-opening reactive functionalities that are complementary to the one or more surface reactive functional groups is glycidyl methacrylate.

The ring structure of such reactive functionalities is susceptible to nucleophilic ring-opening reactions with complementary reactive functional groups on the surface of the ophthalmic device being treated. For example, the epoxide functionality can react with primary amines, hydroxyl radicals, carboxyl radical or the like which may be present on the surface of the ophthalmic device to form a covalent bond between the ophthalmic device at various locations along the copolymer of the coating composition utilizing the monomeric units derived from an ethylenically unsaturated containing monomer having ring-opening reactive functionalities. Accordingly, the ring-opening reactive functionalities of the monomeric units derived from an ethylenically unsaturated containing monomer having ring-opening reactive functionalities form a plurality of attachments to the complementary reactive functional groups on the surface of the ophthalmic device being treated to form a layer of the copolymer.

The copolymers further include monomeric units derived from a hydrophilic monomer having an ethylenically unsaturated reactive group. Suitable ethylenically unsaturated reactive groups can be any of those discussed above. Suitable hydrophilic monomers include, for example, unsaturated carboxylic acids, acrylamides, vinyl lactams, hydroxyl-containing (meth)acrylates, hydrophilic vinyl carbonates, hydrophilic vinyl carbamates, hydrophilic oxazolones, and poly(alkene glycols) functionalized with polymerizable groups and the like and mixtures thereof. Representative examples of unsaturated carboxylic acids include methacrylic acid, acrylic acid and the like and mixtures thereof. Representative examples of amides include alkylamides such as N,N-dimethylacrylamide, N,N-dimethylmethacrylamide and the like and mixtures thereof. Representative examples of cyclic lactams include N-vinyl-2-pyrrolidone, N-vinyl caprolactam, N-vinyl-2-piperidone and the like and mixtures thereof. Representative examples of hydroxyl-containing (meth)acrylates include 2-hydroxyethyl methacrylate (HEMA), glycerol methacrylate and the like and mixtures thereof. Still further examples are the hydrophilic vinyl carbonate or vinyl carbamate monomers disclosed in U.S. Pat. No. 5,070,215, and the hydrophilic oxazolone monomers disclosed in U.S. Pat. No. 4,910,277. Other suitable hydrophilic monomers will be apparent to one skilled in the art. Mixtures of the foregoing hydrophilic monomers can also be used in the monomeric mixtures herein.

In some embodiments, a hydrophilic monomer having an ethylenically unsaturated reactive group can be vinyl chloro formate. The vinyl chloro formate has vinyl groups for attaching to the backbone of the copolymer and a chloro group can be subsequently reacted with an OH group or an amine group to provide a functional derivative, e.g., vinyl chloroformate (Cl—COOCH═CH2) that can provide a —NH—COOCH═CH₂ functional derivative or a —O—COOCH═CH₂ functional derivative depending on the reaction with the NH₂— or OH— group, respectively.

In some embodiments, a hydrophilic monomer having an ethylenically unsaturated reactive group is an alkylacrylamide monomer. Suitable alkylacrylamides include, for example, N,N-dimethylacrylamide, N,N-dimethylmethacrylamide, and the like.

In a non-limiting illustrative embodiment, a copolymer can be represented by the following structure:

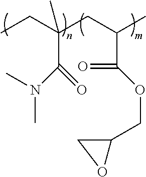

where n is from about 75 to about 90 and m is from about 10 to about 25.

The copolymers can be prepared using free radical polymerization techniques with the structure of the polymer being completely random or controlled by the reactivity ratios of the respective monomers.

In some embodiments, a random copolymer can be obtained by (1) mixing the ethylenically unsaturated containing monomer having ring-opening reactive functionalities and the hydrophilic monomer, (2) adding a polymerization initiator, (3) and subjecting the monomer/initiator mixture to a source of heat. The amount of the ethylenically unsaturated containing monomers having ring-opening reactive functionalities in the mixture can range from about 10 mol % to about 25 mol % and the amount of the hydrophilic monomer can range from about 75 mol % to about 90 mol %.

Suitable initiators include free-radical-generating polymerization initiators of the type illustrated by acetyl peroxide, lauroyl peroxide, decanoyl peroxide, caprylyl peroxide, benzoyl peroxide, tertiary butyl peroxypivalate, sodium percarbonate, tertiary butyl peroctoate, and azobis-isobutyronitrile (AIBN). A level of initiator employed will vary within the range of 0.01 to 2 wt. %, based on the total weight of the mixture. If desired, the mixture of the above-mentioned monomers is warmed with addition of a free-radical former.

In some embodiments, the reaction can be carried out until all of the ethylenically unsaturated containing monomer having ring-opening reactive functionalities has been reacted. Suitable polymerization conditions include, for example, a temperature of between about 15° C. to about 120° C. for a time period of about 30 minutes to about 48 hours. If desired, the reaction can be carried out in the presence of a suitable solvent. Suitable solvents are in principle all solvents which dissolve the monomers used including, for example, 1,4-dioxane, hexanol, dimethylformamide; acetone, cyclohexanone, toluene, and the like and mixtures thereof.

The copolymers disclosed herein can be prepared using techniques of controlled radical polymerization, e.g., by reversible addition-fragmentation chain transfer (RAFT) polymerization or atom-transfer radical polymerization (ATRP) employing a chain transfer agent that allows construction of copolymers with a well-defined molecular weight distribution and narrow polydispersity. RAFT polymerization is particularly preferred because it is compatible with a wide variety of vinyl monomers.

In non-limiting illustrative embodiments, the RAFT agents suitable for use herein can be based upon thio carbonyl thio chemistry which is well known to those of ordinary skill in the art. The thio carbonyl thio fragment can be derived from a RAFT agent such as, for example, a xanthate-containing compound, trithiocarbonate-containing compound, dithiocarbamate-containing compound, a dithiobenzoate-containing compound or dithio ester-containing compound, wherein each compound contains a thio carbonyl thio group. One class of RAFT agents that can be used herein is of the general formula:

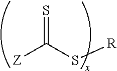

wherein x is 1 or 2, Z is a substituted oxygen (e.g., xanthates (—O—R)), a substituted nitrogen (e.g., dithiocarbamates (—NRR)), a substituted sulfur (e.g., trithiocarbonates (—S—R)), a dithiobenzoate, a substituted or unsubstituted C₁-C₂₀ alkyl or C₃-C₂₅ unsaturated, or partially or fully saturated ring (e.g., dithioesters (—R)) or carboxylic acid-containing group; and R is independently a straight or branched, substituted or unsubstituted C₁-C₃₀ alkyl cyano group, a straight or branched, substituted or unsubstituted C₁-C₃₀ alkyl group, a substituted or unsubstituted C₃-C₃₀ cycloalkyl group, a substituted or unsubstituted C₃-C₃₀ cycloalkylalkyl group, a substituted or unsubstituted C₃-C₃₀ cycloalkenyl group, a substituted or unsubstituted C₅-C₃₀ aryl group, a substituted or unsubstituted C₅-C₃₀ arylalkyl group, a C₁-C₂₀ ester group; an ether or polyether-containing group; an alkyl- or arylamide group; an alkyl- or arylamine group; a substituted or unsubstituted C₅-C₃₀ heteroaryl group; a substituted or unsubstituted C₃-C₃₀ heterocyclic ring; a substituted or unsubstituted C₄-C₃₀ heterocycloalkyl group; a substituted or unsubstituted C₆-C₃₀ heteroarylalkyl group; and combinations thereof.

Representative examples of alkyl groups for use herein include, by way of example, a straight or branched alkyl chain radical containing carbon and hydrogen atoms of from 1 to about 30 carbon atoms and preferably from 1 to about 12 carbon atoms with or without unsaturation, to the rest of the molecule, e.g., methyl, ethyl, n-propyl, 1-methylethyl (isopropyl), n-butyl, n-pentyl, methylene, ethylene, etc., and the like.

Representative examples of cycloalkyl groups for use herein include, by way of example, a substituted or unsubstituted non-aromatic mono or multicyclic ring system of about 3 to about 30 carbon atoms and preferably from 3 to about 6 carbon atoms such as, for example, cyclopropyl, cyclobutyl, cyclopentyl, cyclohexyl, perhydronapththyl, adamantyl and norbornyl groups, bridged cyclic groups or sprirobicyclic groups, e.g., spiro-(4,4)-non-2-yl and the like, optionally containing one or more heteroatoms, e.g., O and N, and the like.

Representative examples of cycloalkylalkyl groups for use herein include, by way of example, a substituted or unsubstituted cyclic ring-containing radical containing from about 3 to about 30 carbon atoms and preferably from 3 to about 6 carbon atoms directly attached to the alkyl group which are then attached to the main structure of the monomer at any carbon from the alkyl group that results in the creation of a stable structure such as, for example, cyclopropylmethyl, cyclobutylethyl, cyclopentylethyl and the like, wherein the cyclic ring can optionally contain one or more heteroatoms, e.g., O and N, and the like.

Representative examples of cycloalkenyl groups for use herein include, by way of example, a substituted or unsubstituted cyclic ring-containing radical containing from about 3 to about 30 carbon atoms and preferably from 3 to about 6 carbon atoms with at least one carbon-carbon double bond such as, for example, cyclopropenyl, cyclobutenyl, cyclopentenyl and the like, wherein the cyclic ring can optionally contain one or more heteroatoms, e.g., O and N, and the like.

Representative examples of aryl groups for use herein include, by way of example, a substituted or unsubstituted monoaromatic or polyaromatic radical containing from about 5 to about 30 carbon atoms such as, for example, phenyl, naphthyl, tetrahydronapthyl, indenyl, biphenyl and the like, optionally containing one or more heteroatoms, e.g., O and N, and the like.

Representative examples of arylalkyl groups for use herein include, by way of example, a substituted or unsubstituted aryl group as defined herein directly bonded to an alkyl group as defined herein, e.g., —CH₂C₆H₅, —C₂H₅C₆H₅ and the like, wherein the aryl group can optionally contain one or more heteroatoms, e.g., O and N, and the like.

Representative examples of ester groups for use herein include, by way of example, a carboxylic acid ester having one to 20 carbon atoms and the like.

Representative examples of ether or polyether containing groups for use herein include, by way of example, an alkyl ether, cycloalkyl ether, cycloalkylalkyl ether, cycloalkenyl ether, aryl ether, arylalkyl ether wherein the alkyl, cycloalkyl, cycloalkylalkyl, cycloalkenyl, aryl, and arylalkyl groups are as defined herein. Exemplary ether or polyether-containing groups include, by way of example, alkylene oxides, poly(alkylene oxide) s such as ethylene oxide, propylene oxide, butylene oxide, poly(ethylene oxide) s, poly(ethylene glycol) s, poly(propylene oxide) s, poly(butylene oxide) s and mixtures or copolymers thereof, an ether or polyether group of the general formula —(R²OR³)ₜ, wherein R² is a bond, a substituted or unsubstituted alkyl, cycloalkyl or aryl group as defined herein and R³ is a substituted or unsubstituted alkyl, cycloalkyl or aryl group as defined herein and tis at least 1, e.g., CH₂CH₂OC₆H₅ and CH₂—CH₂—CH₂—O—CH₂—(CF₂)_{z}—H where z is 1 to 6, —CH₂CH₂OC₂H₅, and the like.

Representative examples of alkyl or arylamide groups for use herein include, by way of example, an amide of the general formula —R⁴C(O)NR⁵R⁶ wherein R⁴, R⁵ and R⁶ are independently C₁-C₃₀ hydrocarbons, e.g., R⁴ can be alkylene groups, arylene groups, cycloalkylene groups and R⁵ and R⁶ can be alkyl groups, aryl groups, and cycloalkyl groups as defined herein and the like.

Representative examples of alky or arylamine groups for use herein include, by way of example, an amine of the general formula —R⁷N R⁸R⁹ wherein R₇ is a C₂-C₃₀ alkylene, arylene, or cycloalkylene and R⁸ and R⁹ are independently C₁-C₃₀ hydrocarbons such as, for example, alkyl groups, aryl groups, or cycloalkyl groups as defined herein.

Representative examples of heterocyclic ring groups for use herein include, by way of example, a substituted or unsubstituted stable 3 to about 30 membered ring radical, containing carbon atoms and from one to five heteroatoms, e.g., nitrogen, phosphorus, oxygen, sulfur and mixtures thereof. Suitable heterocyclic ring radicals for use herein may be a monocyclic, bicyclic or tricyclic ring system, which may include fused, bridged or spiro ring systems, and the nitrogen, phosphorus, carbon, oxygen or sulfur atoms in the heterocyclic ring radical may be optionally oxidized to various oxidation states. In addition, the nitrogen atom may be optionally quaternized; and the ring radical may be partially or fully saturated (i.e., heteroaromatic or heteroaryl aromatic).

Representative examples of heteroaryl groups for use herein include, by way of example, a substituted or unsubstituted heterocyclic ring radical as defined herein. The heteroaryl ring radical may be attached to the main structure at any heteroatom or carbon atom that results in the creation of a stable structure.

Representative examples of heteroarylalkyl groups for use herein include, by way of example, a substituted or unsubstituted heteroaryl ring radical as defined herein directly bonded to an alkyl group as defined herein. The heteroarylalkyl radical may be attached to the main structure at any carbon atom from the alkyl group that results in the creation of a stable structure.

Representative examples of heterocyclic groups for use herein include, by way of example, a substituted or unsubstituted heterocylic ring radical as defined herein. The heterocyclic ring radical may be attached to the main structure at any heteroatom or carbon atom that results in the creation of a stable structure.

Representative examples of heterocycloalkyl groups for use herein include, by way of example, a substituted or unsubstituted heterocylic ring radical as defined herein directly bonded to an alkyl group as defined herein. The heterocycloalkyl radical may be attached to the main structure at any carbon atom in the alkyl group that results in the creation of a stable structure.

The substituents in the ‘substituted oxygen’, ‘substituted nitrogen’, ‘substituted sulfur’, ‘substituted alkyl’, ‘substituted alkylene, ‘substituted cycloalkyl’, ‘substituted cycloalkylalkyl’, ‘substituted cycloalkenyl’, ‘substituted arylalkyl’, ‘substituted aryl’, ‘substituted heterocyclic ring’, ‘substituted heteroaryl ring,’ ‘substituted heteroarylalkyl’, ‘substituted heterocycloalkyl ring’, ‘substituted cyclic ring’ may be the same or different and include one or more substituents such as hydrogen, hydroxy, halogen, carboxyl, cyano, nitro, oxo (═O), thio (═S), substituted or unsubstituted alkyl, substituted or unsubstituted alkoxy, substituted or unsubstituted alkenyl, substituted or unsubstituted alkynyl, substituted or unsubstituted aryl, substituted or unsubstituted arylalkyl, substituted or unsubstituted cycloalkyl, substituted or unsubstituted cycloalkenyl, substituted or unsubstituted amino, substituted or unsubstituted aryl, substituted or unsubstituted heteroaryl, substituted heterocycloalkyl ring, substituted or unsubstituted heteroarylalkyl, substituted or unsubstituted heterocyclic ring, and the like.

Representative examples of RAFT agents for use herein include, but are not limited to, 4-cyano-4-(dodecyl-sulfanylthiocarbonyl) sulfanylpentanoic acid, S-cyanomethyl-5-dodecyltrithiocarbonate, S-(2-cyano-2-propyl)-S-dodecyltrithiocarbonate, 3-benzylsulfanylthiocarbonylsulfanyl-propionic acid, cumyl dithiobenzoate, 2-cyanoprop-2-yl dithiobenzoate (i.e., cyanoisopropyl dithiobenzoate), 4-thiobenzoylsulfanyl-4-cyanopentanoic acid (TCA), S,S′-bis(α,α′-dimethyl-alpha″-acetic acid)-trithiocarbonate (BATC), benzyl dodecyl trithiocarbonate, ethyl-2-dodecyl trithiocarbony) proprionate, S-sec propionic acid O-ethyl xanthate, α-ethyl xanthylphenylacetic acid, ethyl α-(o-ethyl xanthyl) proprionate, ethyl α-(ethyl xanthyl) phenyl acetate, ethyl 2-(dodecyl trithiocarbonyl) phenyl acetate, ethyl 2-(dodecyl trithiocarbonyl) propionate, 2-(dodecylthiocarbonylthiol) propanoic acid, and the like and mixtures thereof.

There is no particular limitation on the organic chemistry used to form the RAFT agent and is within the purview of one skilled in the art.

The copolymers disclosed herein can be obtained in a first step (a) by (1) mixing either the ethylenically unsaturated containing monomer having ring-opening reactive functionalities or the hydrophilic monomer with a RAFT agent; (2) adding a polymerization initiator; (3) and subjecting the monomer/RAFT agent/initiator mixture to a source of heat. Suitable initiators include, for example, free-radical-generating polymerization initiators of the type illustrated by acetyl peroxide, lauroyl peroxide, decanoyl peroxide, coprylyl peroxide, benzoyl peroxide, tertiary butyl peroxypivalate, sodium percarbonate, tertiary butyl peroctoate, and azobisisobutyronitrile (AIBN).

The reaction can be carried out at a temperature of between about 15° C. to about 120° C. for a time period of about 30 minutes to about 48 hours. If desired, the reaction can be carried out in the presence of a suitable solvent. Suitable solvents are in principle all solvents which dissolve the monomer used, for example, 1,4-dioxane, hexanol, dimethylformamide; acetone, cyclohexanone, toluene, and the like and mixtures thereof.

In an illustrative embodiment, the ethylenically unsaturated containing monomer having ring-opening reactive functionalities or the hydrophilic monomer is employed in an amount ranging from about 10 wt. % to about 50 wt. %, based on the total weight of the mixture. In an illustrative embodiment, the RAFT agent is employed in an amount ranging from about 0.5 wt. % to about 3 wt. %, based on the total weight of the mixture. The level of initiator employed will vary within the range of 0.01 wt. % to 2 wt. % of the mixture of monomers. If desired, the mixture of the above-mentioned monomers is warmed with addition of a free-radical former.

Next, in a step (b) the resulting product of step (a) is then mixed with the other one of the ethylenically unsaturated containing monomer having ring-opening reactive functionalities or the hydrophilic monomer and an initiator and subjected to a source of heat as described above until the desired copolymer is formed. In an illustrative embodiment, the other one of the ethylenically unsaturated containing monomer having ring-opening reactive functionalities or the hydrophilic monomer is employed in an amount ranging from about 10 wt. % to about 50 wt. %, based on the total weight of the mixture. In an illustrative embodiment, the resulting product of step (a) is employed in an amount ranging from about 1 wt. % to about 20 wt. %, based on the total weight of the mixture.

A non-limiting schematic representation of a synthetic method for making the block copolymer with a RAFT agent is set forth below in Scheme I

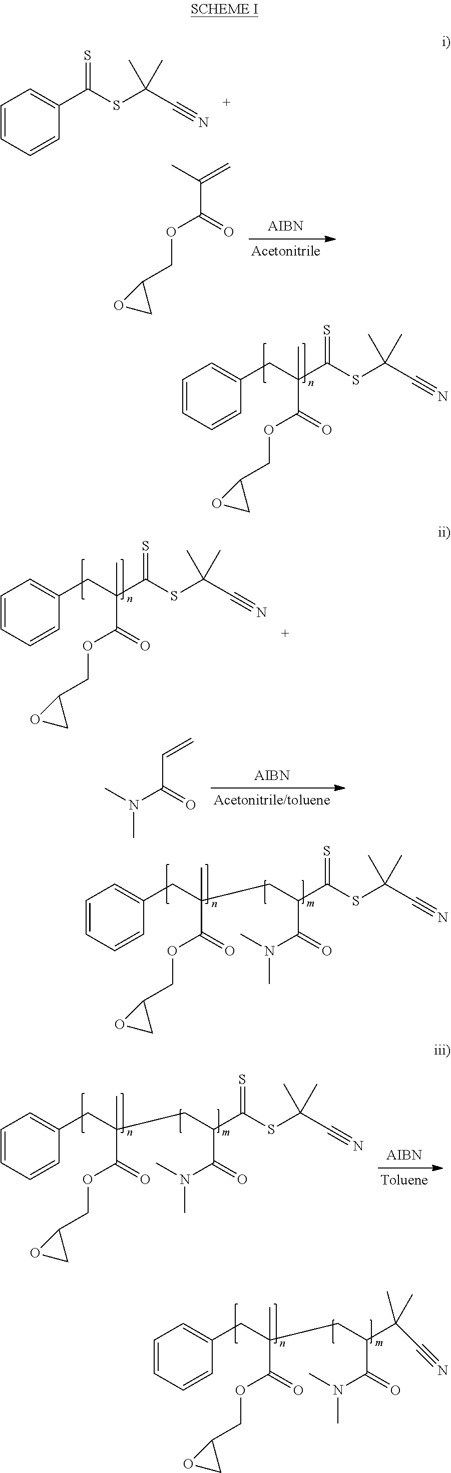

where m is about 75 to about 90, n is about 10 to about 25.

As one skilled in the art will readily appreciate, the copolymer disclosed herein can contain a balance of monomeric units derived from the ethylenically unsaturated containing monomer having ring-opening reactive functionalities and monomeric units derived from the hydrophilic monomer. In some embodiments, a copolymer can include from about 10 mol. % to about 25 mol % of repeating units of the monomeric units derived from an ethylenically unsaturated containing monomer having ring-opening reactive functionalities and from about 75 mol. % to about 90 mol % of repeating units of the monomeric units derived from a hydrophilic monomer. In some embodiments, a copolymer can include from about 12 mol. % to about 20 mol % of repeating units of the monomeric units derived from an ethylenically unsaturated containing monomer having ring-opening reactive functionalities and from about 80 to about 88 mol % of repeating units of the monomeric units derived from a hydrophilic monomer.

Any combination of the foregoing ranges of numbers of monomeric units derived from ethylenically unsaturated containing monomers having ring-opening reactive functionalities and numbers of monomeric units derived from a hydrophilic monomer are contemplated herein.

In one or more additional non-limiting illustrative embodiments, as may be combined with one or more of the preceding paragraphs, the coating compositions further includes a hydrophilic polymer having reactive functional groups.

In one or more additional non-limiting illustrative embodiments, as may be combined with one or more of the preceding paragraphs, the hydrophilic polymer having reactive functional groups comprises reactive repeating units comprising one or more of an amino reactive functional group, a hydroxyl reactive functional group, a thiol reactive functional group and a carboxyl reactive functional group. Suitable amino reactive functional groups include, for example, —NH₂ or —NHR where R is an alkyl group. Suitable hydroxyl reactive functional groups include, for example, —OH. Suitable thiol reactive functional groups include, for example, —SH. Suitable carboxyl reactive functional groups include, for example, —COOH or —COO—.

In some embodiments, the hydrophilic polymer having reactive functional groups comprises a biopolymer. In a non-limiting illustrative embodiment, a biopolymer for use herein can be reactive repeating units derived from gelatin. Generally, gelatin is a product obtained by the partial hydrolysis of collagen derived from the skin, white connective tissue, and bones of animals. It is a derived protein comprising various amino acids linked between adjacent amino and carbonyl groups to provide a peptide bond. The amino acid combinations in gelatin provide amphoteric properties, which are responsible for varying isoelectric values, depending somewhat upon the methods of processing.

In some embodiments, gelatin can comprise a Type A gelatin, a Type B gelatin, or a combination comprising at least one of the foregoing. A Type A gelatin results from acid pretreatment (swelling of the raw material in the presence of acid) and is generally made from frozen pork skins treated in dilute acid (e.g., HCl, H₂SO₃, H₃PO₄, or H₂SO₄) at a pH of 1 to 2 for about 10 to about 30 hours, after which it is water washed to remove excess acid, followed by extraction and drying in the conventional manner. A Type B gelatin results from alkali pretreatment (swelling of the raw material in the presence of an alkali) and is generally made from ossein or hide stock. In some embodiments, the amino acid profile for Type A and Type B gelatin is set forth below.

Amino Acid Profile for Type A and Type B Gelatin

| | Type A | (Porkskin) | Type B | (Calf Skin) | Type B | (Bone) |
|---|---|---|---|---|---|---|
| Alanine | 8.6 | 10.7 | 9.3 | 11.0 | 10.1 | 14.2 |
| Arginine | 8.3 | 9.1 | 8.55 | 8.8 | 5.0 | 9.0 |
| Aspartic Acid | 6.2 | 6.7 | 6.6 | 6.9 | 4.6 | 6.7 |
| Cystine | 0.1 | | Trace | Trace | Trace | Trace |
| Glutamic Acid | 11.3 | 11.7 | 11.1 | 11.4 | 8.5 | 11.6 |
| Glycine | 26.4 | 30.5 | 26.9 | 27.5 | 24.5 | 28.8 |
| Histidine | 0.9 | 1.0 | 0.74 | 0.8 | 0.4 | 0.7 |
| Hydroxylysine | 1.0 | | 0.91 | 1.2 | 0.7 | 0.9 |
| Hydroxyproline | 13.5 | | 14.0 | 14.5 | 11.9 | 13.4 |
| Isoleucine | 1.4 | | 1.7 | 1.8 | 1.3 | 1.5 |
| Leucine | 3.1 | 3.3 | 3.1 | 3.4 | 2.8 | 3.5 |
| Lysine | 4.1 | 5.2 | 4.5 | 4.6 | 2.1 | 4.4 |
| Methionone | 0.8 | 0.9 | 0.8 | 0.9 | 0.0 | 0.6 |
| Phenylalanine | 2.1 | 2.6 | 2.2 | 2.5 | 1.3 | 2.5 |
| Proline | 16.2 | 18.0 | 14.8 | 16.4 | 13.5 | 15.5 |
| Serine | 2.9 | 4.1 | 3.2 | 4.2 | 3.4 | 3.8 |
| Threonine | 2.2 | | 2.2 | | 2.0 | 2.4 |
| Tyrosine | 0.4 | 0.9 | 0.2 | 1.0 | 0.0 | 0.2 |
| Valine | 2.5 | 2.8 | 2.6 | 3.4 | 2.4 | 3.0 |

In some embodiments, the hydrophilic polymer having reactive functional groups comprises reactive repeating units derived from an amino acid. Suitable amino acids include, for example, one or more of glycine, alanine, crysteine, valine, leucine, isoleucine, methionine, phenylalanine, tyrosine, tryptophan, aspartic acid, glutamic acid, serine, asparagine, glutamine, histidine, lysine, polylysine, polyethyleneimine, arginine, histidine, proline, aspartic acid, and threonine.

In some embodiments, the hydrophilic polymer having reactive functional groups comprises reactive repeating units derived from a polyamine. In some embodiments, suitable polyamines include those having greater than or equal to two amine groups, or greater than or equal to three amine groups, or greater than or equal to four amine groups, or greater than or equal to five amine groups or greater than or equal to six amine groups. Suitable polyamines include, for example, polyethyleneimine. In some embodiments, a suitable polyethyleneimine can be a polyethylencimine having a weight average molecular weight ranging from about 4 k Daltons (kDa) to about 200 kDa.

In some embodiments, the hydrophilic polymer having reactive functional groups comprises reactive repeating units derived from a glycosaminoglycan. A GAG is one molecule with many alternating subunits. In general, GAGs are represented by the formula A-B-A-B-A-B, where A is a uronic acid and B is an amino sugar that may or may not be either O- or N-sulfated, where the A and B units can be heterogeneous with respect to epimeric content or sulfation. Any natural or synthetic polymer containing uronic acid can be used. Other GAGs are sulfated at different sugars. There are many different types of GAGs having commonly understood structures such as, for example, chondroitin, chondroitin sulfate (e.g., chondroitin 4- and 6-sulfates), dermatan, dermatan sulfate, heparin, heparan sulfate, heparosan, hyaluronan, hyaluronic acid or a salt thereof, e.g., sodium hyaluronate or potassium hyaluronate, heparosan, keratan sulfate, and other disaccharides such as sucrose, lactulose, lactose, maltose, trehalose, cellobiose, mannobiose and chitobiose. Glycosaminoglycans can be purchased from Sigma, and many other biochemical suppliers such as HTL Biotechnology (France). In one illustrative embodiment, the GAG is hyaluronic acid. In one embodiment, the GAG is chondroitin sulfate.

The GAGs will have a reactive functional group in the polymer backbone for reacting with the copolymer. Suitable reactive functional groups in the polymer backbone include, for example, carboxylic-containing groups, carboxylate-containing groups, hydroxyl-containing groups, silicone hydride groups, sulfur-containing groups such as thiols and other groups including polymerizable functionalities such as allylic, vinylic, acrylate, methacrylate, methacrylamide, etc. In addition, the sugar rings of the GAGs can be opened to form aldehydes for further functionalization. In some embodiments, GAGs for use herein can have a weight average molecular weight ranging from about 5 kDa to about 200 kDa.

Hyaluronic acid is a well-known, naturally occurring, water soluble biodegradable polymer composed of two alternatively linked sugars, D-glucuronic acid and N-acetylglucosamine, linked via alternating β-(1,4) and β-(1,3) glycosidic bonds. Hyaluronic acid is a non-sulfated GAG. The polymer is hydrophilic and highly viscous in aqueous solution at relatively low solute concentrations. It often occurs naturally as the sodium salt, sodium hyaluronate. Methods of preparing commercially available hyaluronan and salts thereof are well known. Hyaluronan can be purchased from Seikagaku Company, Clear Solutions Biotech, Inc., Pharmacia Inc., Sigma Inc., and many other suppliers HTL Biotechnology, Contipro and Bloomage Biotechnology Corporation. Hyaluronic acid has repeating units of the structure represented by the following formula:

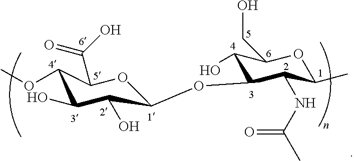

where n is from 10 to about 1,000,000.

Accordingly, the repeating units in hyaluronic acid can be as follows:

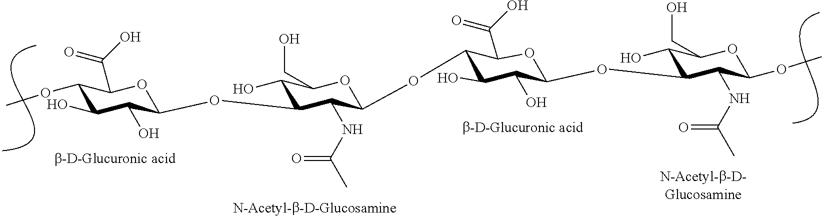

Chondroitin sulfate is a linear sulfated polysaccharide composed of repeating β-D-glucuronic acid (GlcA) and N-acetyl-β-D-galactosamine (GalNAc) units arranged in the sequence by GlcA-B β(1,3)-GalNAc- β(1,4) glycosidic bonds. In one embodiment, chondroitin sulfate has one or more repeating units of the structure represented by the following formula:

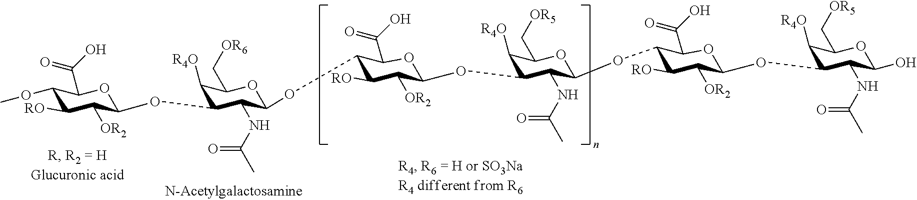

where n is from 10 to about 1,000,000.

In one illustrative embodiment, chondroitin sulfate has repeating units of the structure represented by the following formula:

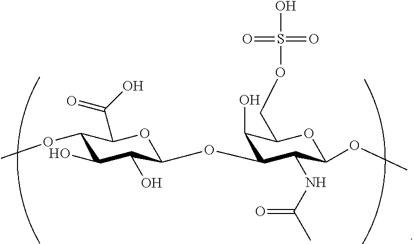

In one illustrative embodiment, dermatan sulfate has repeating units of the structure represented by the following formula:

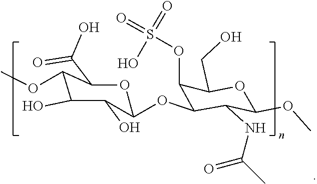

where n is from 10 to about 1,000,000.

In one illustrative embodiment, heparin and heparin sulfate has repeating units of the structure represented by the following formula:

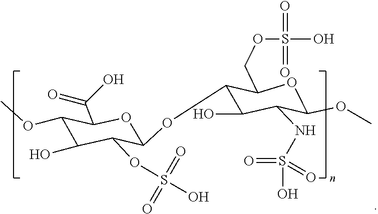

where n is from 10 to about 1,000,000.

In one illustrative embodiment, keratan sulfate has repeating units of the structure represented by the following formula:

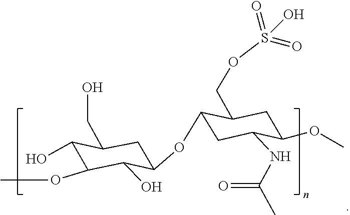

Where n is from 10 to about 1,000,000.

In some embodiments, the hydrophilic polymer having reactive functional groups comprises reactive repeating units derived from derived from a cellulose material. Suitable cellulose material includes, for example, one or more of hydroxypropyl methyl cellulose and carboxy methyl cellulose. In some embodiments, the cellulose material for use herein can have a weight average molecular weight ranging from about 10 to about 1,000,000.

In some embodiments, a hydrophilic polymer having amino reactive functional groups comprises reactive repeating units derived from one or more of trimethylolpropane polyoxypropylene, lysine, arginine, histidine, proline, allylamine hydrochloride, ethyleneimine and ethylenimine.

In some embodiments, a hydrophilic polymer having thiol reactive functional groups comprises reactive repeating units derived from cysteine.

In some embodiments, a hydrophilic polymer having COOH and/or COO-reactive functional groups comprises reactive repeating units derived from one or more of aspartic acid, glutamic acid, sodium acrylate, acrylic acid, hyaluronic acid, HPMC (Hydroxypropyl methyl cellulose) and CMC (Carboxy methyl cellulose).

In some embodiments, a hydrophilic polymer having hydroxyl reactive functional groups comprises reactive repeating units derived from one or more of serine, threonine, vinyl alcohol and hyaluronic acid.

In one or more additional non-limiting illustrative embodiments, as may be combined with one or more of the preceding paragraphs, the hydrophilic polymer having reactive functional groups comprises reactive repeating units comprising the reactive functional groups. In some embodiments, the hydrophilic polymer comprises from about 5 mol % to about 100 mol % of the reactive repeating units. In some embodiments, the hydrophilic polymer comprises from about 10 mol % to about 100 mol % of the reactive repeating units. In some embodiments, the hydrophilic polymer comprises from about 5 mol. % to about 30 mol % of the reactive repeating units. In some embodiments, the hydrophilic polymer comprises from about 10 mol. % to about 20 mol % of the reactive repeating units.

In one or more additional non-limiting illustrative embodiments, as may be combined with one or more of the preceding paragraphs, a coating composition disclosed herein can contain less than or equal to about 1 wt. %, based on the total weight of the coating composition, of the hydrophilic polymer having reactive functional groups with the remaining amount being the copolymer comprising (i) monomeric units derived from an ethylenically unsaturated containing monomer having ring-opening reactive functionalities, and (ii) monomeric units derived from a hydrophilic monomer. In some embodiments, a coating composition disclosed herein can contain from about 99 wt. % to about 99.9 wt. %, based on the total weight of the coating composition, of the copolymer comprising (i) monomeric units derived from an ethylenically unsaturated containing monomer having ring-opening reactive functionalities, and (ii) monomeric units derived from a hydrophilic monomer and from about 0.1 wt. % to about 1 wt. %, based on the total weight of the coating composition, of the hydrophilic polymer having reactive functional groups.

In one or more additional non-limiting illustrative embodiments, as may be combined with one or more of the preceding paragraphs, an ophthalmic device having one or more surface reactive functional groups is then exposed to the coating composition disclosed herein to form a surface coating on the ophthalmic device. In some embodiments, the step of forming the surface coating can comprise exposing the ophthalmic device having one or more surface reactive functional groups to the coating composition to adsorb, entangle or covalently attach given ones of the ring-opening reactive functionalities of the monomeric units derived from an ethylenically unsaturated containing monomer having ring-opening reactive functionalities of the copolymer to the surface reactive functional groups of the ophthalmic device. In addition, given other ones of the ring-opening reactive functionalities of the monomeric units derived from an ethylenically unsaturated containing monomer having ring-opening reactive functionalities of the copolymer will adsorb, entangle or covalently attach to the reactive functional groups of the hydrophilic polymer having reactive functional groups to form the surface coating. In this manner, a robust interlocked surface coating on a surface of the ophthalmic device can be obtained.

Entanglement of the copolymer to the ophthalmic device is understood to mean structures formed by the cross-linking points between intermolecular or intramolecular polymer chains, making the polymer chains unable to move normally and thus trapping them into the bulk matrix. In addition, absorption of the copolymer to the ophthalmic device involves intermolecular forces brought about by electrostatic interaction, hydrogen bonding, and van der Waals forces.

In some embodiments, the step of forming the surface coating can comprise immersing an ophthalmic device in the coating composition and heating to temperature and for a time period sufficient to form a surface coating on the ophthalmic device. In some embodiments, a suitable temperature can range from about 70° C. to about 130° C. In some embodiments, a suitable time period can range from about 30 minutes to about 6 hours.

In non-limiting illustrative embodiments, the ophthalmic device can be released from a mold assembly and then contacted with an aqueous packaging solution containing the coating composition disclosed herein. For example, the ophthalmic device can be transferred to an individual lens package containing a buffered saline solution containing at least the coating composition disclosed herein and subjected to sterilization.

In non-limiting illustrative embodiments, the coating composition disclosed herein is present in the aqueous packaging solution in an amount ranging from about 0.1 wt. % to about 2 wt. %, based on the total weight of the aqueous packaging solution. In some embodiments, the coating composition disclosed herein is present in the aqueous packaging solution in an amount ranging from about 0.2 wt. % to about 1 wt. %, based on the total weight of the aqueous packaging solution. In some embodiments, the coating composition disclosed herein is present in the aqueous packaging solution in an amount ranging from about 0.2 wt. % to about 0.4 wt. %, based on the total weight of the aqueous packaging solution.

Appropriate packaging designs and materials are known in the art. A plastic package is releasably sealed with a film. Suitable sealing films are known in the art and include foils, polymer films and mixtures thereof. The sealed packages containing the lenses are then sterilized to ensure a sterile product. Suitable sterilization means and conditions are known in the art and include, for example, steam sterilizing or autoclaving of the sealed container at temperatures of about 120° C. or higher.

The packaging solutions of the illustrative embodiments are physiologically compatible. Specifically, the solution must be “ophthalmically safe” for use with a lens such as a contact lens, meaning that a contact lens treated with the solution is generally suitable and safe for direct placement on the eye without rinsing, that is, the solution is safe and comfortable for daily contact with the eye via a contact lens that has been wetted with the solution. An ophthalmically safe solution has a tonicity and pH that is compatible with the eye and includes materials, and amounts thereof, that are non-cytotoxic according to ISO standards and U.S. Food & Drug Administration (FDA) regulations.

The packaging solution should also be sterile in that the absence of microbial contaminants in the product prior to release must be statistically demonstrated to the degree necessary for such products. The liquid media useful in the present invention are selected to have no substantial detrimental effect on the lens being treated or cared for and to allow or even facilitate the present lens treatment or treatments. The liquid media are preferably aqueous-based. A particularly useful aqueous liquid medium is that derived from saline, for example, a conventional saline solution or a conventional buffered saline solution.

The pH of the present solutions is maintained within the range of about 6 to about 9, and preferably about 6.5 to about 7.8. As mentioned above, additional buffer may optionally be added, such as boric acid, sodium borate, potassium citrate, sodium citrate, citric acid, sodium bicarbonate, various mixed phosphate buffers (including combinations of Na₂ HPO₄, NaH₂ PO₄ and KH₂ PO₄), hydrates thereof and the like and mixtures thereof. Generally, buffers will be used in amounts ranging from about 0.05 to about 2.5 percent by weight, and preferably from about 0.1 to about 1.5 percent by weight of the solution. However, according to certain embodiments, tris(hydroxymethyl) aminomethane, or salts thereof, function as the sole buffer.

In one embodiment, the aqueous packaging solution can further comprise one or more buffer agents. Suitable one or more buffer agents include, for example, phosphate buffer agents, borate buffer agents, citrate buffer agents, and the like. A suitable phosphate buffer agent can be any known phosphate buffer agents. In one embodiment, the phosphate buffer agent comprises one or more of sodium hydrogen phosphate monobasic, sodium hydrogen phosphate dibasic, potassium hydrogen phosphate monobasic and potassium hydrogen phosphate dibasic and any suitable hydrate thereof, e.g., monohydrate and heptahydrate. A suitable borate buffer agent can be any known borate buffer agents. In one embodiment, the borate buffer agent comprises one or more of boric acid and sodium borate. A suitable citrate buffer agent can be any known citrate buffer agents. In one embodiment, the citrate buffer agent comprises one or more of citric acid and sodium citrate.

In one embodiment, the one or more buffer agents are present in the aqueous packaging solution in an amount ranging from about 0.001 wt. % to about 2 wt. %, based on the total weight of the packaging solution. In one embodiment, the phosphate buffer agent is present in the packaging solution in an amount ranging from about 0.001 wt. % to about 1 wt. %, based on the total weight of the packaging solution.

Typically, the aqueous packaging solutions are also adjusted with tonicity agents, to approximate the osmotic pressure of normal lacrimal fluids which is equivalent to a 0.9 percent solution of sodium chloride or 2.5 percent of glycerol solution. The solutions are made substantially isotonic with physiological saline used alone or in combination, otherwise if simply blended with sterile water and made hypotonic or made hypertonic the lenses will lose their desirable optical parameters. Correspondingly, excess saline may result in the formation of a hypertonic solution which will cause stinging and eye irritation.

Examples of suitable tonicity adjusting agents include, but are not limited to, sodium and potassium chloride, dextrose, glycerin, calcium and magnesium chloride and the like and mixtures thereof. These agents are typically used individually in amounts ranging from about 0.01 to about 2.5% w/v and preferably from about 0.2% w/v to about 1.5% w/v. Preferably, the tonicity agent will be employed in an amount to provide a final osmotic value of at least about 200 mOsm/kg, or from about 200 to about 400 mOsm/kg, or from about 250 to about 350 mOsm/kg, or from about 280 to about 320 mOsm/kg.

If desired, one or more additional components can be included in the packaging solution. Such an additional component or components are chosen to impart or provide at least one beneficial or desired property to the packaging solution. Such additional components may be selected from components which are conventionally used in one or more ophthalmic device care compositions. Examples of such additional components include cleaning agents, wetting agents, nutrient agents, sequestering agents, viscosity builders, contact lens conditioning agents, antioxidants, and the like and mixtures thereof. These additional components may each be included in the packaging solutions in an amount effective to impart or provide the beneficial or desired property to the packaging solutions. For example, such additional components may be included in the packaging solutions in amounts similar to the amounts of such components used in other, e.g., conventional, contact lens care products.

Useful sequestering agents include, but are not limited to, disodium ethylene diamine tetraacetate, alkali metal hexametaphosphate, citric acid, sodium citrate and the like and mixtures thereof.

Useful viscosity builders include, but are not limited to, hydroxyethyl cellulose, hydroxymethyl cellulose, polyvinyl pyrrolidone, polyvinyl alcohol and the like and mixtures thereof.

Useful antioxidants include, but are not limited to, sodium metabisulfite, sodium thiosulfate, N-acetylcysteine, butylated hydroxyanisole, butylated hydroxytoluene and the like and mixtures thereof.

The method of packaging and storing an ophthalmic device such as a contact lens includes at least packaging an ophthalmic device immersed in the aqueous packaging solution containing the coating composition disclosed herein and sterilizing the packaged solution. The method may include immersing the ophthalmic device in the aqueous packaging solution containing the coating composition disclosed herein prior to delivery to the customer/wearer, directly following manufacture of the contact lens. Alternately, the packaging and storing in the aqueous packaging solution containing the coating composition disclosed herein may occur at an intermediate point before delivery to the ultimate customer (wearer) but following manufacture and transportation of a contact lens in a dry state, wherein a dry contact lens is hydrated by immersing the contact lens in the aqueous packaging solution containing the coating composition disclosed herein. Consequently, a package for delivery to a customer may include a sealed container containing one or more unused surface modified contact lenses immersed in the aqueous packaging solution.

After polymerization is completed, any non-covalently bonded monomers, oligomers or polymers formed can be removed, for example, by treatment with a suitable solvent. The resulting surface modified ophthalmic device can then be used “as is”. In other words, no additional surface treatment steps will have to be carried out to modify the resulting surface modified ophthalmic device. As used herein, the phrase “without any additional surface treatment steps” shall be understood to mean that the exterior surface of the surface modified ophthalmic device of the illustrative embodiments is not further treated to modify the surface thereof by, for example, oxidation treatments, plasma treatments, grafting treatments, coating treatments and the like. However, it shall be understood that coatings such as color or other cosmetic enhancement may be applied to devices disclosed herein.

The following examples are provided to enable one skilled in the art to practice the invention and are merely illustrative of the invention. The examples should not be read as limiting the scope of the invention as defined in the claims.

### Contact Angle

Captive bubble contact angle data was collected on a First Ten Angstroms FTA-1000 prop Shape Instrument. All samples were rinsed in HPLC grade water prior to analysis in order to remove components of the packaging solution from the sample surface. Prior to data collection the surface tension of the water used for all experiments was measured using the pendant drop method. In order for the water to qualify as appropriate for use, a surface tension value of 70-72 dynes/cm was expected. All lens samples were placed onto a curved sample holder and submerged into a quartz cell filled with HPLC grade water. Advancing and receding captive bubble contact angles were collected for each sample. The advancing contact angle is defined as the angle measured in water as the air bubble is retracting from the lens surface (water is advancing across the surface). All captive bubble data was collected using a high speed digital camera focused onto the sample/air bubble interface. The contact angle was calculated at the digital frame just prior to contact line movement across the sample/air bubble interface. The receding contact angle is defined as the angle measured in water as the air bubble is expanding across the sample surface (water is receding from the surface).

Sessile Drop Method-Contact angles reported in the Examples were also determined according to the Sessile Drop Method first developed by Zisman, W. A., et al., J. Colloid Sci., Vol. 1, p. 513 (1946). A plastic film with support was placed on a flat plate in a Rane-Hart goniometer. A drop of liquid of interest (distilled water, buffered saline or any other liquid of interest) was applied to the film through a metered syringe. The angle was read from the viewer, after adjusting the baseline.

### Example 1A

### Preparation of a Coating Composition.

First, 3 mg/mL (0.3%) gelatin was prepared in a phosphate buffer solution by dissolving 30 mg of gelatin [Type A, 175 Bloom; Lot: XO8H053; CAS: 9000-70-8] in 10 mL phosphate buffer solution. As gelatin is not soluble at room temperature, the temperature of the phosphate buffer solution was raised to 80° C. and the solution was continuously stirred until the gelatin was completely dissolved. The 3 mg/mL gelatin solution in phosphate buffer solution was then cooled down to room temperature. Next, 30 mg of poly (GMA-DMA) having 15 units of GMA and 85 units of DMA was then added to the phosphate buffer solution containing 3 mg/ml (0.3%) gelatin. The resulting coating composition was then stirred to dissolve all poly (GMA-DMA).

### Example 1B

### Preparation of Surface Modified Contact Lens.

A hydrated silicon hydrogel lens was placed in the 3 mL coating solution of Example 1A. The lens remained in the coating solution for 30 minutes and autoclaved at 120° C.

Contact angles were measured for both coated and uncoated lenes multiple times as presented below in Tables 1 and 2.

TABLE 1
Captive Bubble Advancing Contact

| Run | Uncoated Lens | Coated Lens |
|---|---|---|
| 1 | 89 | 40 |
| 2 | 87 | 39 |
| 3 | 90 | 38 |
| 4 | 86 | 39 |
| 5 | 87 | 41 |
| 6 | 90 | 37 |

TABLE 2
Sessile Drop Contact Angle

| Run | Uncoated Lens | Coated Lens |
|---|---|---|
| 1 | 88 | 60 |
| 2 | 86 | 58 |
| 3 | 87 | 59 |
| 4 | 89 | 58 |
| 5 | 87 | 58 |
| 6 | 90 | 59 |

As can be seen, both the captive bubble advancing contact angle and the sessile drop contact angle measurements showed a decreased in contact angles for the coated lenses compared to uncoated lenses. These lenses were rubbed and autoclaved 2 times at 120° C. to establish the durability of coating. It has been found that the lenses were lubricious even after two cycles of autoclave.

### Example 2A

### Preparation of a Coating Composition.

First, 300 mg of poly (GMA-DMA) having 15 units of GMA and 85 units of DMA was added to a 100 mL phosphate buffer solution and stirred until all of the poly (GMA-DMA) was completely dissolved. To this solution, 12 mg of a branched polyethyleneimine (PEI) having a Mw 25 k Da, a Mn 10 k Da, and a PDI 2.5 was added and mixed. The resulting coating composition was then stirred to dissolve all PEI.

### Example 2B

### Preparation of a Surface Modified Contact Lens.

A hydrated silicon hydrogel lens was placed in the 3 mL coating solution of Example 2A. The lens remained in the coating solution for 30 minutes and autoclaved at 120° C.

Contact angles were measured for both coated and uncoated lenes multiple times as presented below in Tables 3.

TABLE 3
Sessile Drop Contact Angle

| Run | Uncoated Lens | Coated Lens |
|---|---|---|
| 1 | 88 | 68 |
| 2 | 86 | 67 |
| 3 | 87 | 70 |
| 4 | 89 | 73 |
| 5 | 87 | 74 |
| 6 | 90 | 72 |

As can be seen, the sessile drop contact angle measurements showed a decrease in contact angles for the coated lenses compared to uncoated lenses. These lenses were rubbed and autoclaved 2 times at 120° C. to establish the durability of coating. It has been found that the lenses were lubricious even after two cycles of autoclave.

While compositions and methods are described in terms of “comprising” various components or steps, the compositions and methods can also “consist essentially of” or “consist of” the various components or steps, unless stated otherwise.

The terms “a,” “an,” and “the” are intended to include plural alternatives, e.g., at least one. The terms “including,” “with,” and “having,” as used herein, are defined as comprising (i.e., open language), unless specified otherwise.

Various numerical ranges are disclosed herein. When Applicant discloses or claims a range of any type, Applicant's intent is to disclose or claim individually each possible number that such a range could reasonably encompass, including end points of the range as well as any sub-ranges and combinations of sub-ranges encompassed therein, unless otherwise specified. For example, all numerical end points of ranges disclosed herein are approximate, unless excluded by proviso.

Values or ranges may be expressed herein as “about,” from “about” one particular value, and/or to “about” another particular value. When such values or ranges are expressed, other embodiments disclosed include the specific value recited, from the one particular value, and/or to the other particular value. Similarly, when values are expressed as approximations, by use of the antecedent “about,” it will be understood that the particular value forms another embodiment. It will be further understood that there are a number of values disclosed therein, and that each value is also herein disclosed as “about” that particular value in addition to the value itself. In another aspect, use of the term “about” means±20% of the stated value, ±15% of the stated value, ±10% of the stated value, ±5% of the stated value, ±3% of the stated value, or ±1% of the stated value.

Applicant reserves the right to proviso out or exclude any individual members of any such group of values or ranges, including any sub-ranges or combinations of sub-ranges within the group, that can be claimed according to a range or in any similar manner, if for any reason Applicant chooses to claim less than the full measure of the disclosure, for example, to account for a reference that Applicant may be unaware of at the time of the filing of the application. Further, Applicant reserves the right to proviso out or exclude any members of a claimed group.

According to an aspect of the present disclosure, a surface modified ophthalmic device comprises an ophthalmic device having one or more surface reactive functional groups and a surface coating, the surface coating being derived from a coating composition comprising (a) a copolymer comprising (i) monomeric units derived from an ethylenically unsaturated containing monomer having ring-opening reactive functionalities, and (ii) monomeric units derived from a hydrophilic monomer having an ethylenically unsaturated reactive group, and (b) a hydrophilic polymer having reactive functional groups, wherein first ones of the ring-opening reactive functionalities of the ethylenically unsaturated containing monomer are complementary to the one or more surface reactive functional groups of the ophthalmic device and second ones of the ring-opening reactive functionalities of the ethylenically unsaturated containing monomer are complementary to the reactive functional groups of the hydrophilic polymer.

In non-limiting illustrative embodiments, as may be combined with one or more of the preceding paragraphs, the first ones of the ring-opening reactive functionalities of the ethylenically unsaturated containing monomer are adsorbed, entangled or covalently attached to the surface of the ophthalmic device through the one or more surface reactive functional groups, and the second ones of the ring-opening reactive functionalities of the ethylenically unsaturated containing monomer are adsorbed, entangled or covalently attached to the reactive functional groups of the hydrophilic polymer.

In non-limiting illustrative embodiments, as may be combined with one or more of the preceding paragraphs, the one or more surface reactive functional groups of the ophthalmic device are selected from the group consisting of a hydroxy group, a tosylate group, a mesylate group, a triflate group, a nosyloxy group, an amino group, a carboxy group, a carbonyl group, an aldehyde group, thiol group, nitro group, nitrile group, a sulfonic acid group, a sulfonyl chloride group, an isocyanato group, a carboxy anhydride group, a lactone group, an azlactone group, an epoxy group, a group capable of undergoing Michael addition-type reaction and mixtures thereof.

In non-limiting illustrative embodiments, as may be combined with one or more of the preceding paragraphs, the one or more surface reactive functional groups of the ophthalmic device are selected from the group consisting of a hydroxy group, an amino group, a carboxy group and mixtures thereof and the ring-opening reactive functionalities that are complementary to the one or more surface reactive functional groups is an epoxy group.

In non-limiting illustrative embodiments, as may be combined with one or more of the preceding paragraphs, the ethylenically unsaturated containing monomer having ring-opening reactive functionalities contains 2 to about 18 carbon atoms which is substituted by an epoxy group.

In non-limiting illustrative embodiments, as may be combined with one or more of the preceding paragraphs, the hydrophilic monomer is selected from the group consisting of an unsaturated carboxylic acid, an acrylamide, a vinyl lactam, a hydroxyl-containing (meth)acrylate, a hydrophilic vinyl carbonate, a hydrophilic vinyl carbamate monomer, a hydrophilic oxazolone monomer, vinyl chloro formate and mixtures thereof.

In non-limiting illustrative embodiments, as may be combined with one or more of the preceding paragraphs, the ethylenically unsaturated containing monomer having ring-opening reactive functionalities is glycidyl methacrylate and the hydrophilic monomer is dimethylacrylamide.

In non-limiting illustrative embodiments, as may be combined with one or more of the preceding paragraphs, the copolymer comprises from about 10 mol. % to about 25 mol % of the monomeric units derived from the ethylenically unsaturated containing monomer having ring-opening reactive functionalities and from about 75 mol. % to about 90 mol % of the monomeric units derived from the hydrophilic monomer.

In non-limiting illustrative embodiments, as may be combined with one or more of the preceding paragraphs, the hydrophilic polymer having reactive functional groups comprises reactive repeating units comprising one or more of an amino reactive functional group, a hydroxyl reactive functional group, a thiol reactive functional group and a carboxyl reactive functional group.

In non-limiting illustrative embodiments, as may be combined with one or more of the preceding paragraphs, the hydrophilic polymer comprises from about 10 mol. % to about 100 mol % of the reactive repeating units.

In non-limiting illustrative embodiments, as may be combined with one or more of the preceding paragraphs, the hydrophilic polymer having reactive functional groups comprises reactive repeating units derived from gelatin.

In non-limiting illustrative embodiments, as may be combined with one or more of the preceding paragraphs, the gelatin is a Type A gelatin.

In non-limiting illustrative embodiments, as may be combined with one or more of the preceding paragraphs, the hydrophilic polymer having reactive functional groups comprises reactive repeating units derived from an amino acid.

In non-limiting illustrative embodiments, as may be combined with one or more of the preceding paragraphs, the amino acid comprises one or more of glycine, alanine, crysteine, valine, leucine, isoleucine, methionine, phenylalanine, tyrosine, tryptophan, aspartic acid, glutamic acid, serine, asparagine, glutamine, histidine, lysine, polylysine, polyethyleneimine, arginine, histidine, proline, aspartic acid, and threonine.

In non-limiting illustrative embodiments, as may be combined with one or more of the preceding paragraphs, the hydrophilic polymer having reactive functional groups comprises reactive repeating units derived from a glycosaminoglycan.

In non-limiting illustrative embodiments, as may be combined with one or more of the preceding paragraphs, the glycosaminoglycan is selected from the group consisting of chondroitin, chondroitin sulfate, dermatan, dermatan sulfate, heparin, heparan sulfate, heparosan, hyaluronan, and hyaluronic acid or a salt thereof.

In non-limiting illustrative embodiments, as may be combined with one or more of the preceding paragraphs, the hydrophilic polymer having reactive functional groups comprises reactive repeating units derived from a cellulose material.

In non-limiting illustrative embodiments, as may be combined with one or more of the preceding paragraphs, the cellulose is one or more of hydroxypropyl methyl cellulose and carboxy methyl cellulose.

In non-limiting illustrative embodiments, as may be combined with one or more of the preceding paragraphs, the hydrophilic polymer having reactive functional groups comprises reactive repeating units derived from sodium acrylate, acrylic acid and vinyl alcohol.

In non-limiting illustrative embodiments, as may be combined with one or more of the preceding paragraphs, the hydrophilic polymer having reactive functional groups comprises reactive repeating units derived from a polyamine.

In non-limiting illustrative embodiments, as may be combined with one or more of the preceding paragraphs, the copolymer is a brush copolymer.

In non-limiting illustrative embodiments, as may be combined with one or more of the preceding paragraphs, the copolymer is a random copolymer.

In non-limiting illustrative embodiments, as may be combined with one or more of the preceding paragraphs, the coating composition comprises from about 0.1 wt. % to about 1 wt. %, based on the total weight of the coating composition, of the hydrophilic polymer having reactive functional groups.

In non-limiting illustrative embodiments, as may be combined with one or more of the preceding paragraphs, the copolymer comprises the remaining amount in the coating composition.

In non-limiting illustrative embodiments, as may be combined with one or more of the preceding paragraphs, the coating composition comprises greater than or equal to 99 wt. %, based on the total weight of the coating composition, of the copolymer.

In non-limiting illustrative embodiments, as may be combined with one or more of the preceding paragraphs, the ophthalmic device is an ophthalmic lens.

In non-limiting illustrative embodiments, as may be combined with one or more of the preceding paragraphs, the ophthalmic lens is a contact lens or an intraocular lens.

In non-limiting illustrative embodiments, as may be combined with one or more of the preceding paragraphs, the ophthalmic device is a silicone contact lens.

In non-limiting illustrative embodiments, as may be combined with one or more of the preceding paragraphs, the ophthalmic device is a silicone hydrogel continuous-wear lens.

According to another aspect of the present disclosure, a method for making an ophthalmic device having a surface coating comprises exposing an ophthalmic device having one or more surface reactive functional groups to a coating composition comprising (a) a copolymer comprising (i) monomeric units derived from an ethylenically unsaturated containing monomer having ring-opening reactive functionalities, and (ii) monomeric units derived from a hydrophilic monomer having an ethylenically unsaturated reactive group, and (b) a hydrophilic polymer having reactive functional groups, wherein first ones of the ring-opening reactive functionalities of the ethylenically unsaturated containing monomer are complementary to the one or more surface reactive functional groups of the ophthalmic device and second ones of the ring-opening reactive functionalities of the ethylenically unsaturated containing monomer are complementary to the reactive functional groups of the hydrophilic polymer.

In non-limiting illustrative embodiments, as may be combined with one or more of the preceding paragraphs, the step of exposing comprises contacting the ophthalmic device having one or more surface reactive functional groups to the coating composition.

In non-limiting illustrative embodiments, as may be combined with one or more of the preceding paragraphs, the one or more surface reactive functional groups of the ophthalmic device are selected from the group consisting of a hydroxy group, a tosylate group, a mesylate group, a triflate group, a nosyloxy group, an amino group, a carboxy group, a carbonyl group, an aldehyde group, a sulfonic acid group, a sulfonyl chloride group, an isocyanato group, a carboxy anhydride group, a lactone group, an azlactone group, an epoxy group, a group capable of undergoing Michael addition-type reaction and mixtures thereof.

In non-limiting illustrative embodiments, as may be combined with one or more of the preceding paragraphs, the first ones of the ring-opening reactive functionalities of the ethylenically unsaturated containing monomer are adsorbed, entangled or covalently attached to the surface of the ophthalmic device through the one or more surface reactive functional groups, and the second ones of the ring-opening reactive functionalities of the ethylenically unsaturated containing monomer are adsorbed, entangled or covalently attached to the reactive functional groups of the hydrophilic polymer.

In non-limiting illustrative embodiments, as may be combined with one or more of the preceding paragraphs, the one or more surface reactive functional groups of the ophthalmic device are selected from the group consisting of a hydroxy group, an amino group, a carboxy group and mixtures thereof and the ring-opening reactive functionalities that are complementary to the one or more surface reactive functional groups is an epoxy group.

In non-limiting illustrative embodiments, as may be combined with one or more of the preceding paragraphs, the ethylenically unsaturated containing monomer having ring-opening reactive functionalities contains 2 to about 18 carbon atoms which is substituted by an epoxy group.

In non-limiting illustrative embodiments, as may be combined with one or more of the preceding paragraphs, the hydrophilic monomer is selected from the group consisting of an unsaturated carboxylic acid, an acrylamide, a vinyl lactam, a hydroxyl-containing (meth)acrylate, a hydrophilic vinyl carbonate, a hydrophilic vinyl carbamate monomer, a hydrophilic oxazolone monomer, vinyl chloro formate and mixtures thereof.

In non-limiting illustrative embodiments, as may be combined with one or more of the preceding paragraphs, the ethylenically unsaturated containing monomer having ring-opening reactive functionalities is glycidyl methacrylate and the hydrophilic monomer is dimethylacrylamide.

In non-limiting illustrative embodiments, as may be combined with one or more of the preceding paragraphs, the copolymer comprises from about 10 mol. % to about 25 mol. % of the monomeric units derived from the ethylenically unsaturated containing monomer having ring-opening reactive functionalities and from about 75 mol. % to about 90 mol. % of the monomeric units derived from the hydrophilic monomer.

In non-limiting illustrative embodiments, as may be combined with one or more of the preceding paragraphs, the hydrophilic polymer having reactive functional groups comprises reactive repeating units comprising one or more of an amino reactive functional group, a hydroxyl reactive functional group, a thiol reactive functional group and a carboxyl reactive functional group.

In non-limiting illustrative embodiments, as may be combined with one or more of the preceding paragraphs, the hydrophilic polymer comprises from about 10 mol. % to about 100 mol % of the reactive repeating units.

In non-limiting illustrative embodiments, as may be combined with one or more of the preceding paragraphs, the hydrophilic polymer having reactive functional groups comprises reactive repeating units derived from gelatin.

In non-limiting illustrative embodiments, as may be combined with one or more of the preceding paragraphs, the gelatin is a Type A gelatin.

In non-limiting illustrative embodiments, as may be combined with one or more of the preceding paragraphs, the hydrophilic polymer having reactive functional groups comprises reactive repeating units derived from an amino acid.

In non-limiting illustrative embodiments, as may be combined with one or more of the preceding paragraphs, the amino acid comprises one or more of glycine, alanine, cysteine valine, leucine, isoleucine, methionine, phenylalanine, tyrosine, tryptophan, aspartic acid, glutamic acid, serine, asparagine, glutamine, histidine, lysine, polylysine, polyethyleneimine, arginine, histidine, proline, aspartic acid, and threonine.

In non-limiting illustrative embodiments, as may be combined with one or more of the preceding paragraphs, the hydrophilic polymer having reactive functional groups comprises reactive repeating units derived from a glycosaminoglycan.

In non-limiting illustrative embodiments, as may be combined with one or more of the preceding paragraphs, the glycosaminoglycan is selected from the group consisting of chondroitin, chondroitin sulfate, dermatan, dermatan sulfate, heparin, heparan sulfate, heparosan, hyaluronan, and hyaluronic acid or a salt thereof.

In non-limiting illustrative embodiments, as may be combined with one or more of the preceding paragraphs, the hydrophilic polymer having reactive functional groups comprises reactive repeating units derived from a cellulose material.

In non-limiting illustrative embodiments, as may be combined with one or more of the preceding paragraphs, the cellulose is one or more of hydroxypropyl methyl cellulose and carboxy methyl cellulose.

In non-limiting illustrative embodiments, as may be combined with one or more of the preceding paragraphs, the hydrophilic polymer having reactive functional groups comprises reactive repeating units derived from sodium acrylate, acrylic acid and vinyl alcohol.

In non-limiting illustrative embodiments, as may be combined with one or more of the preceding paragraphs, the hydrophilic polymer having reactive functional groups comprises reactive repeating units derived from a polyamine.

In non-limiting illustrative embodiments, as may be combined with one or more of the preceding paragraphs, the copolymer is a brush copolymer.

In non-limiting illustrative embodiments, as may be combined with one or more of the preceding paragraphs, the copolymer is a random copolymer.

In non-limiting illustrative embodiments, as may be combined with one or more of the preceding paragraphs, the coating composition comprises from about 0.1 wt. % to about 1 wt. %, based on the total weight of the coating composition, of the hydrophilic polymer having reactive functional groups.

In non-limiting illustrative embodiments, as may be combined with one or more of the preceding paragraphs, the copolymer comprises the remaining amount in the coating composition.

In non-limiting illustrative embodiments, as may be combined with one or more of the preceding paragraphs, the coating composition comprises greater than or equal to 99 wt. %, based on the total weight of the coating composition, of the copolymer.

In non-limiting illustrative embodiments, as may be combined with one or more of the preceding paragraphs, the ophthalmic device is an ophthalmic lens.

In non-limiting illustrative embodiments, as may be combined with one or more of the preceding paragraphs, the ophthalmic lens is a contact lens or an intraocular lens.

In non-limiting illustrative embodiments, as may be combined with one or more of the preceding paragraphs, the ophthalmic device is a silicone contact lens.

In non-limiting illustrative embodiments, as may be combined with one or more of the preceding paragraphs, the ophthalmic device is a silicone hydrogel continuous-wear lens.

According to another aspect of the present disclosure, a packaging system for the storage of a surface modified ophthalmic device comprises a sealed container containing an unused ophthalmic device immersed in an aqueous packaging solution comprising a coating composition comprising (a) a copolymer comprising (i) monomeric units derived from an ethylenically unsaturated containing monomer having ring-opening reactive functionalities, and (ii) monomeric units derived from a hydrophilic monomer having an ethylenically unsaturated reactive group, and (b) a hydrophilic polymer having reactive functional groups, wherein first ones of the ring-opening reactive functionalities of the ethylenically unsaturated containing monomer are complementary to the one or more surface reactive functional groups of the ophthalmic device and second ones of the ring-opening reactive functionalities of the ethylenically unsaturated containing monomer are complementary to the reactive functional groups of the hydrophilic polymer; wherein the aqueous packaging solution has an osmolality of at least about 150 mOsm/kg, a pH of about 6 to about 9 and is sterilized.

In non-limiting illustrative embodiments, as may be combined with one or more of the preceding paragraphs, the first ones of the ring-opening reactive functionalities of the ethylenically unsaturated containing monomer are adsorbed, entangled or covalently attached to the surface of the ophthalmic device through the one or more surface reactive functional groups, and the second ones of the ring-opening reactive functionalities of the ethylenically unsaturated containing monomer are adsorbed, entangled or covalently attached to the reactive functional groups of the hydrophilic polymer.

In non-limiting illustrative embodiments, as may be combined with one or more of the preceding paragraphs, the one or more surface reactive functional groups of the ophthalmic device are selected from the group consisting of a hydroxy group, a tosylate group, a mesylate group, a triflate group, a nosyloxy group, an amino group, a carboxy group, a carbonyl group, an aldehyde group, thiol group, nitro group, nitrile group, a sulfonic acid group, a sulfonyl chloride group, an isocyanato group, a carboxy anhydride group, a lactone group, an azlactone group, an epoxy group, a group capable of undergoing Michael addition-type reaction and mixtures thereof.

In non-limiting illustrative embodiments, as may be combined with one or more of the preceding paragraphs, the one or more surface reactive functional groups of the ophthalmic device are selected from the group consisting of a hydroxy group, an amino group, a carboxy group and mixtures thereof and the ring-opening reactive functionalities that are complementary to the one or more surface reactive functional groups is an epoxy group.

In non-limiting illustrative embodiments, as may be combined with one or more of the preceding paragraphs, the ethylenically unsaturated containing monomer having ring-opening reactive functionalities contains 2 to about 18 carbon atoms which is substituted by an epoxy group.

In non-limiting illustrative embodiments, as may be combined with one or more of the preceding paragraphs, the hydrophilic monomer is selected from the group consisting of an unsaturated carboxylic acid, an acrylamide, a vinyl lactam, a hydroxyl-containing (meth)acrylate, a hydrophilic vinyl carbonate, a hydrophilic vinyl carbamate monomer, a hydrophilic oxazolone monomer, vinyl chloro formate and mixtures thereof.

In non-limiting illustrative embodiments, as may be combined with one or more of the preceding paragraphs, the ethylenically unsaturated containing monomer having ring-opening reactive functionalities is glycidyl methacrylate and the hydrophilic monomer is dimethylacrylamide.

In non-limiting illustrative embodiments, as may be combined with one or more of the preceding paragraphs, the copolymer comprises from about 10 mol. % to about 25 mol % of the monomeric units derived from the ethylenically unsaturated containing monomer having ring-opening reactive functionalities and from about 75 mol. % to about 90 mol % of the monomeric units derived from the hydrophilic monomer.

In non-limiting illustrative embodiments, as may be combined with one or more of the preceding paragraphs, the hydrophilic polymer having reactive functional groups comprises reactive repeating units comprising one or more of an amino reactive functional group, a hydroxyl reactive functional group, a thiol reactive functional group and a carboxyl reactive functional group.

In non-limiting illustrative embodiments, as may be combined with one or more of the preceding paragraphs, the hydrophilic polymer comprises from about 10 mol. % to about 100 mol % of the reactive repeating units.

In non-limiting illustrative embodiments, as may be combined with one or more of the preceding paragraphs, the hydrophilic polymer having reactive functional groups comprises reactive repeating units derived from gelatin.

In non-limiting illustrative embodiments, as may be combined with one or more of the preceding paragraphs, the gelatin is a Type A gelatin.

In non-limiting illustrative embodiments, as may be combined with one or more of the preceding paragraphs, the hydrophilic polymer having reactive functional groups comprises reactive repeating units derived from an amino acid.

In non-limiting illustrative embodiments, as may be combined with one or more of the preceding paragraphs, the amino acid comprises one or more of glycine, alanine, crysteine, valine, leucine, isoleucine, methionine, phenylalanine, tyrosine, tryptophan, aspartic acid, glutamic acid, serine, asparagine, glutamine, histidine, lysine, polylysine, polyethyleneimine, arginine, histidine, proline, aspartic acid, and threonine.

In non-limiting illustrative embodiments, as may be combined with one or more of the preceding paragraphs, the hydrophilic polymer having reactive functional groups comprises reactive repeating units derived from a glycosaminoglycan.

In non-limiting illustrative embodiments, as may be combined with one or more of the preceding paragraphs, the glycosaminoglycan is selected from the group consisting of chondroitin, chondroitin sulfate, dermatan, dermatan sulfate, heparin, heparan sulfate, heparosan, hyaluronan, and hyaluronic acid or a salt thereof.

In non-limiting illustrative embodiments, as may be combined with one or more of the preceding paragraphs, the hydrophilic polymer having reactive functional groups comprises reactive repeating units derived from a cellulose material.

In non-limiting illustrative embodiments, as may be combined with one or more of the preceding paragraphs, the cellulose is one or more of hydroxypropyl methyl cellulose and carboxy methyl cellulose.

In non-limiting illustrative embodiments, as may be combined with one or more of the preceding paragraphs, the hydrophilic polymer having reactive functional groups comprises reactive repeating units derived from sodium acrylate, acrylic acid and vinyl alcohol.

In non-limiting illustrative embodiments, as may be combined with one or more of the preceding paragraphs, the hydrophilic polymer having reactive functional groups comprises reactive repeating units derived from a polyamine.

In non-limiting illustrative embodiments, as may be combined with one or more of the preceding paragraphs, the copolymer is a brush copolymer.

In non-limiting illustrative embodiments, as may be combined with one or more of the preceding paragraphs, the copolymer is a random copolymer.

In non-limiting illustrative embodiments, as may be combined with one or more of the preceding paragraphs, the coating composition comprises from about 0.1 wt. % to about 1 wt. %, based on the total weight of the coating composition, of the hydrophilic polymer having reactive functional groups.

In non-limiting illustrative embodiments, as may be combined with one or more of the preceding paragraphs, the copolymer comprises the remaining amount in the coating composition.

In non-limiting illustrative embodiments, as may be combined with one or more of the preceding paragraphs, the coating composition comprises greater than or equal to 99 wt. %, based on the total weight of the coating composition, of the copolymer.

In non-limiting illustrative embodiments, as may be combined with one or more of the preceding paragraphs, the ophthalmic device is an ophthalmic lens.

In non-limiting illustrative embodiments, as may be combined with one or more of the preceding paragraphs, the ophthalmic lens is a contact lens or an intraocular lens.

In non-limiting illustrative embodiments, as may be combined with one or more of the preceding paragraphs, the ophthalmic device is a silicone contact lens.

In non-limiting illustrative embodiments, as may be combined with one or more of the preceding paragraphs, the ophthalmic device is a silicone hydrogel continuous-wear lens.

Various features disclosed herein are, for brevity, described in the context of a single embodiment, but may also be provided separately or in any suitable sub-combination. All combinations of the embodiments are specifically embraced by the illustrative embodiments disclosed herein just as if each and every combination was individually and explicitly disclosed. In addition, all sub-combinations listed in the embodiments describing such variables are also specifically embraced by the present compositions and are disclosed herein just as if each and every such sub-combination was individually and explicitly disclosed herein.

It will be understood that various modifications may be made to the embodiments disclosed herein. Therefore, the above description should not be construed as limiting, but merely as exemplifications of preferred embodiments. For example, the functions described above and implemented as the best mode for operating the present invention are for illustration purposes only. Other arrangements and methods may be implemented by those skilled in the art without departing from the scope and spirit of this invention. Moreover, those skilled in the art will envision other modifications within the scope and spirit of the features and advantages appended hereto.

What is claimed is:

1. A surface modified ophthalmic device comprising an ophthalmic device having one or more surface reactive functional groups and a surface coating, the surface coating comprising a coating composition comprising (a) a copolymer comprising (i) monomeric units derived from an ethylenically unsaturated containing monomer having ring-opening reactive functionalities, and (ii) monomeric units derived from a hydrophilic monomer having an ethylenically unsaturated reactive group, and (b) a hydrophilic polymer having reactive functional groups, wherein first ones of the ring-opening reactive functionalities of the ethylenically unsaturated containing monomer are complementary to the one or more surface reactive functional groups of the ophthalmic device and second ones of the ring-opening reactive functionalities of the ethylenically unsaturated containing monomer are complementary to the reactive functional groups of the hydrophilic polymer.

2. The surface modified ophthalmic device according to claim 1, wherein the one or more surface reactive functional groups of the ophthalmic device are selected from the group consisting of a hydroxy group, a tosylate group, a mesylate group, a triflate group, a nosyloxy group, an amino group, a carboxy group, a carbonyl group, an aldehyde group, thiol group, nitro group, nitrile group, a sulfonic acid group, a sulfonyl chloride group, an isocyanato group, a carboxy anhydride group, a lactone group, an azlactone group, an epoxy group, a group capable of undergoing Michael addition-type reaction and mixtures thereof.

3. The surface modified ophthalmic device according to claim 1, wherein the one or more surface reactive functional groups of the ophthalmic device are selected from the group consisting of a hydroxy group, an amino group, a carboxy group and mixtures thereof and the ring-opening reactive functionalities that are complementary to the one or more surface reactive functional groups is an epoxy group.

4. The surface modified ophthalmic device according to claim 1, wherein the ethylenically unsaturated containing monomer having ring-opening reactive functionalities contains 2 to about 18 carbon atoms which is substituted by an epoxy group.

5. The surface modified ophthalmic device according to claim 1, wherein the hydrophilic monomer is selected from the group consisting of an unsaturated carboxylic acid, an acrylamide, a vinyl lactam, a hydroxyl-containing (meth)acrylate, a hydrophilic vinyl carbonate, a hydrophilic vinyl carbamate monomer, a hydrophilic oxazolone monomer, vinyl chloro formate and mixtures thereof.

6. The surface modified ophthalmic device according to claim 1, wherein the ethylenically unsaturated containing monomer having ring-opening reactive functionalities is glycidyl methacrylate and the hydrophilic monomer is dimethylacrylamide.

7. The surface modified ophthalmic device according to claim 1, wherein the copolymer comprises from about 10 mol % to about 25 mol % of the monomeric units derived from the ethylenically unsaturated containing monomer having ring-opening reactive functionalities and from about 75 mol % to about 90 mol % of the monomeric units derived from the hydrophilic monomer.

8. The surface modified ophthalmic device according to claim 1, wherein the hydrophilic polymer having reactive functional groups comprises reactive repeating units comprising one or more of an amino reactive functional group, a hydroxyl reactive functional group, a thiol reactive functional group and a carboxyl reactive functional group.

9. The surface modified ophthalmic device according to claim 8, wherein the hydrophilic polymer comprises from about 10 mol % to about 100 mol % of the reactive repeating units.

10. The surface modified ophthalmic device according to claim 1, wherein the hydrophilic polymer having reactive functional groups comprises reactive repeating units derived from gelatin.

11. The surface modified ophthalmic device according to claim 1, wherein the hydrophilic polymer having reactive functional groups comprises reactive repeating units derived from an amino acid.

12. The surface modified ophthalmic device according to claim 1, wherein the hydrophilic polymer having reactive functional groups comprises reactive repeating units derived from a glycosaminoglycan.

13. The surface modified ophthalmic device according to claim 1, wherein the hydrophilic polymer having reactive functional groups comprises reactive repeating units derived from a cellulose material.

14. The surface modified ophthalmic device according to claim 1, wherein the hydrophilic polymer having reactive functional groups comprises reactive repeating units derived from sodium acrylate, acrylic acid and vinyl alcohol.

15. The surface modified ophthalmic device according to claim 1, wherein the hydrophilic polymer having reactive functional groups comprises reactive repeating units derived from a polyamine.

16. The surface modified ophthalmic device according to claim 1, wherein the copolymer is a brush copolymer.

17. The surface modified ophthalmic device according to claim 1, wherein the coating composition comprises greater than or equal to 99 wt. %, based on the total weight of the coating composition, of the copolymer.

18. The surface modified ophthalmic device according to claim 1, wherein the ophthalmic device is a contact lens or an intraocular lens.

19. A method for making an ophthalmic device having a surface coating, the method comprising exposing an ophthalmic device having one or more surface reactive functional groups to a coating composition comprising (a) a copolymer comprising (i) monomeric units derived from an ethylenically unsaturated containing monomer having ring-opening reactive functionalities, and (ii) monomeric units derived from a hydrophilic monomer having an ethylenically unsaturated reactive group, and (b) a hydrophilic polymer having reactive functional groups, wherein first ones of the ring-opening reactive functionalities of the ethylenically unsaturated containing monomer are complementary to the one or more surface reactive functional groups of the ophthalmic device and second ones of the ring-opening reactive functionalities of the ethylenically unsaturated containing monomer are complementary to the reactive functional groups of the hydrophilic polymer.

20. A packaging system for the storage of a surface modified ophthalmic device, comprising:
a sealed container containing an unused ophthalmic device immersed in an aqueous packaging solution comprising a coating composition comprising (a) a copolymer comprising (i) monomeric units derived from an ethylenically unsaturated containing monomer having ring-opening reactive functionalities, and (ii) monomeric units derived from a hydrophilic monomer having an ethylenically unsaturated reactive group, and (b) a hydrophilic polymer having reactive functional groups, wherein first ones of the ring-opening reactive functionalities of the ethylenically unsaturated containing monomer are complementary to the one or more surface reactive functional groups of the unused ophthalmic device and second ones of the ring-opening reactive functionalities of the ethylenically unsaturated containing monomer are complementary to the reactive functional groups of the hydrophilic polymer; wherein the aqueous packaging solution has an osmolality of at least about 150 mOsm/kg, a pH of about 6 to about 9 and is sterilized.
